(19) United States
(12) Patent Application Publication
(10) Pub. No.: US 2003/0138631 A1
(43) Pub. Date: Jul. 24, 2003

(54) Multicomponent superabsorbent gel particles

(76) Inventors: Michael A. Mitchell, Waxhaw, NC (US); Leticia I. Lobo, Palatine, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/029,546

(22) Filed: Oct. 26, 2001

(51) Int. Cl. B32B 19/00

(52) U.S. Cl. 428/402.22; 428/474.4; 428/405; 428/402

(57) ABSTRACT

Multicomponent superabsorbent gel particles are disclosed. The multicomponent particles comprise at least one acidic water-absorbing resin and at least one basic water-absorbing resin. Each particle contains at least one microdomain of the acidic resin covalently bound to at least one microdomain of the basic resin via an interfacial crosslinking agent. Blends of multicomponent superabsorbent gel particles with particles of a second water-absorbing resin, and improved diaper cores containing particles of the multicomponent superabsorbent gel particles also are disclosed.

### FIELD OF THE INVENTION

The present invention relates to monolithic, multicomponent superabsorbent particles containing at least one acidic water-absorbing resin and at least one basic water-absorbing resin. Each super-absorbent particle has at least one microdomain of the acidic resin covalently bound to at least one microdomain of the basic resin utilizing an inter-facial crosslinking agent. The present invention also relates to mixtures containing (a) monolithic, multicomponent superabsorbent particles, and (b) particles of an acidic water-absorbing resin, a basic water-absorbing resin, or a mixture thereof.

### BACKGROUND OF THE INVENTION

Water-absorbing resins are widely used in sanitary goods, hygienic goods, wiping cloths, water-retaining agents, dehydrating agents, sludge coagulants, disposable towels and bath mats, disposable door mats, thickening agents, disposable litter mats for pets, condensation-preventing agents, and release control agents for various chemicals. Water-absorbing resins are available in a variety of chemical forms, including substituted and unsubstituted natural and synthetic polymers, such as hydrolysis products of starch acrylonitrile graft polymers, carboxymethylcellulose, crosslinked polyacrylates, sulfonated polystyrenes, hydrolyzed polyacrylamides, polyvinyl alcohols, polyethylene oxides, polyvinylpyrrolidones, and polyacrylonitriles.

Such water-absorbing resins are termed “superabsorbent polymers,” or SAPs, and typically are lightly crosslinked hydrophilic polymers. SAPs are generally discussed in Goldman et al. U.S. Pat. Nos. 5,669,894 and 5,559,335, the disclosures of which are incorporated herein by reference. SAPs can differ in their chemical identity, but all SAPs are capable of absorbing and retaining amounts of aqueous fluids equivalent to many times their own weight, even under moderate pressure. For example, SAPs can absorb one hundred times their own weight, or more, of distilled water. The ability to absorb aqueous fluids under a confining pressure is an important requirement for an SAP used in a hygienic article, such as a diaper.

As used here and hereafter, the term “SAP particles” refers to superabsorbent polymer particles in the dry state, i.e., particles containing from no water up to an amount of water less than the weight of the particles. The terms “SAP gel” or “SAP hydrogel” refer to a superabsorbent polymer in the hydrated state, i.e., particles that have absorbed at least their weight in water, and typically several times their weight in water.

The dramatic swelling and absorbent properties of SAPs are attributed to (a) electrostatic repulsion between the charges along the polymer chains, and (b) osmotic pressure of the counter ions. It is known, however, that these absorption properties are drastically reduced in solutions containing electrolytes, such as saline, urine, and blood. The polymers function much less effectively in the presence of such physiologic fluids.

The decreased absorbency of electrolyte-containing liquids is illustrated by the absorption properties of a typical, commercially available SAP, i.e., sodium polyacrylate, in deionized water and in 0.9% by weight sodium chloride (NaCl) solution. The sodium polyacrylate can absorb 146.2 grams (g) of deionized water per gram of SAP (g/g) at 0 psi, 103.8 g of deionized water per gram of polymer at 0.28 psi, and 34.3 g of deionized water per gram of polymer of 0.7 psi. In contrast, the same sodium polyacrylate is capable of absorbing only 43.5 g, 29.7 g, and 24.8 g of 0.9% aqueous NaCl at 0 psi, 0.28 psi, and 0.7 psi, respectively. The absorption capacity of SAPs for body fluids, such as urine or menses, therefore, is dramatically lower than for deionized water because such fluids contain electrolytes. This dramatic decrease in absorption is termed “salt poisoning.”

The salt poisoning effect has been explained as follows. Water-absorption and water-retention characteristics of SAPs are attributed to the presence of ionizable functional groups in the polymer structure. The ionizable groups typically are carboxyl groups, a high proportion of which are in the salt form when the polymer is dry, and which undergo dissociation and salvation upon contact with water. In the dissociated state, the polymer chain contains a plurality of functional groups having the same electric charge and, thus, repel one another. This electronic repulsion leads to expansion of the polymer structure, which, in turn, permits further absorption of water molecules. Polymer expansion, however, is limited by the crosslinks in the polymer structure, which are present in a sufficient number to prevent solubilization of the polymer.

It is theorized that the presence of a significant concentration of electrolytes interferes with dissociation of the ionizable functional groups, and leads to the “salt poisoning” effect. Dissolved ions, such as sodium and chloride ions, therefore, have two effects on SAP gels. The ions screen the polymer charges and the ions eliminate the osmotic imbalance due to the presence of counter ions inside and outside of the gel. The dissolved ions, therefore, effectively convert an ionic gel into a nonionic gel, and swelling properties are lost.

The most commonly used SAP for absorbing electrolyte-containing liquids, such as urine, is neutralized polyacrylic acid, i.e., containing at least 50%, and up to 100%, neutralized carboxyl groups. Neutralized polyacrylic acid, however, is susceptible to salt poisoning. Therefore, to provide an SAP that is less susceptible to salt poisoning, either an SAP different from neutralized polyacrylic acid must be developed, or the neutralized polyacrylic acid must be modified or treated to at least partially overcome the salt poisoning effect.

The removal of ions from electrolyte-containing solutions is often accomplished using ion exchange resins. In this process, deionization is performed by contacting an electrolyte-containing solution with two different types of ion exchange resins, i.e., an anion exchange resin and a cation exchange resin. The most common deionization procedure uses an acid resin (i.e., cation exchange) and a base resin (i.e., anion exchange). The two-step reaction for deionization is illustrated with respect to the desalinization of water as follows:

NaCl+R—SO₃H R→SONa⁺ HCl

HCl+R—N(CH₃)₃OH→R—N(CH₃)₃Cl+H₂O.

The acid resin (R—SO₃H) removes the sodium ion; and the base resin (R—N(CH₃)₃OH) removes the chloride ions. This ion exchange reaction, therefore, produces water as sodium chloride is adsorbed onto the resins. The resins used in ion exchange do not absorb significant amounts of water.

The most efficient ion exchange occurs when strong acid and strong base resins are employed. However, weak acid and weak base resins also can be used to deionize saline solutions. The efficiency of various combinations of acid and base exchange resins are as follows:

Strong acid—strong base (most efficient)

Weak acid—strong base

Strong acid—weak base

Weak acid—weak base (least efficient).

The weak acid/weak base resin combination requires that a “mixed bed” configuration be used to obtain deionization. The strong acid/strong base resin combination does not necessarily require a mixed bed configuration to deionize water. Deionization also can be achieved by sequentially passing the electrolyte-containing solution through a strong acid resin and strong base resin.

A “mixed bed” configuration of the prior art is a physical mixture of an acid ion exchange resin and a base ion exchange resin in an ion exchange column, as disclosed in Battaerd U.S. Pat. No. 3,716,481. Other patents directed to ion exchange resins having one ion exchange resin imbedded in a second ion exchange resin are Hatch U.S. Pat. No. 3,957,698, Wade et al. U.S. Pat. No. 4,139,499, Eppinger et al. U.S. Pat. No. 4,229,545, and Pilkington U.S. Pat. No. 4,378,439. Composite ion exchange resins also are disclosed in Hatch U.S. Pat. Nos. 3,041,092 and 3,332,890, and Weiss U.S. Pat. No. 3,645,922.

The above patents are directed to nonswelling resins that can be used to remove ions from aqueous fluids, and thereby provide purified water. Ion exchange resins used for water purification must not absorb significant amounts of water because resin swelling resulting from absorption can lead to bursting of the ion exchange containment column.

Ion exchange resins or fibers also have been disclosed for use in absorbent personal care devices (e.g., diapers) to control the pH of fluids that reach the skin, as set forth in Berg et al. U.S. Pat. No. 4,685,909. The ion exchange resin is used in this application to reduce diaper rash, but the ion exchange resin is not significantly water absorbent and, therefore, does not improve the absorption and retention properties of the diaper.

Ion exchange resins having a composite particle containing acid and base ion exchange particles embedded together in a matrix resin, or having acid and base ion exchange particles adjacent to one another in a particle that is free of a matrix resin are disclosed in B. A. Bolto et al., J. Polymer Sci. :Symposium No. 55, John Wiley and Sons, Inc. (1976), pages 87-94. The Bolto et al. publication is directed to improving the reaction rates of ion exchange resins for water purification and does not utilize resins that absorb substantial amounts of water.

Other investigators have attempted to counteract the salt poisoning effect and thereby improve the performance of SAPs with respect to absorbing electrolyte-containing liquids, such as menses and urine. For example, Tanaka et al. U.S. Pat. No. 5,274,018 discloses an SAP composition comprising a swellable hydrophilic polymer, such as polyacrylic acid, and an amount of an ionizable surfactant sufficient to form at least a monolayer of surfactant on the polymer. In another embodiment, a cationic gel, such as a gel containing quaternized ammonium groups and in the hydroxide (i.e., OH) form, is admixed with an anionic gel (i.e., a polyacrylic acid) to remove electrolytes from the solution by ion exchange. Quaternized ammonium groups in the hydroxide form are very difficult and time-consuming to manufacture, thereby limiting the practical use of such cationic gels.

Wong U.S. Pat. No. 4,818,598 discloses the addition of a fibrous anion exchange material, such as DEAE (diethylaminoethyl) cellulose, to a hydrogel, such as a polyacrylate, to improve absorption properties. The ion exchange resin “pretreats” the saline solution (e.g., urine) as the solution flows through an absorbent structure (e.g., a diaper). This pretreatment removes a portion of the salt from the saline. The conventional SAP present in the absorbent structure then absorbs the treated saline more efficiently than untreated saline. The ion exchange resin, per se, does not absorb the saline solution, but merely helps overcome the “salt poisoning” effect.

WO 96/17681 discloses admixing discrete anionic SAP particles, such as polyacrylic acid, with discrete polysaccharide-based cationic SAP particles to overcome the salt poisoning effect. Similarly, WO 96/15163 discloses combining a cationic SAP having at least 20% of the functional groups in a basic (i.e., OH) form with a cationic exchange resin, i.e., a nonswelling ion exchange resin, having at least 50% of the functional groups in the acid form. WO 96/15180 discloses an absorbent material comprising an anionic SAP, e.g., a polyacrylic acid and an anion exchange resin, i.e., a nonswelling ion exchange resin.

These references disclose combinations that attempt to overcome the salt poisoning effect. However, the references merely teach the admixture of two types of particles, and do not suggest a single, monolithic particle containing at least one microdomain of an acidic resin covalently bound to at least one microdomain of a basic resin by utilizing an interfacial crosslinking agent. These references also do not teach a mixture of resin particles wherein one component of the mixture is particles of a monolithic, multicomponent SAP.

The present invention, therefore, is directed to discrete SAP particles that exhibit exceptional water absorption and retention properties, especially with respect to electrolyte-containing liquids, and thereby overcome the salt poisoning effect. In addition, the discrete SAP particles have an ability to absorb liquids quickly, demonstrate good fluid permeability and conductivity into and through the SAP particle, and have a high gel strength such that the hydrogel formed from the SAP particles does not deform or flow under an applied stress or pressure, when used alone or in a mixture with other water-absorbing resins.

### SUMMARY OF THE INVENTION

The present invention is directed to monolithic, multicomponent SAPs comprising at least one acidic water-absorbing resin, such as a polyacrylic acid, covalently bound to at least one basic water-absorbing resin, such as a poly(vinylamine) or a polyethyleneimine, utilizing an interfacial cross-linking agent.

More particularly, the present invention is directed to monolithic, multicomponent SAP particles containing at least one discrete microdomain of at least one acidic water-absorbing resin covalently bound to at least one microdomain of at least one basic water-absorbing resin utilizing an interfacial crosslinking agent. The multicomponent SAP particles can contain a plurality of microdomains of the acidic water-absorbing resin and/or the basic water-absorbing resin dispersed throughout the particle. The acidic resin can be a strong or a weak acidic resin. Similarly, the basic resin can be a strong or a weak basic resin.

A preferred SAP contains one or more microdomains of at least one weak acidic resin covalently bound to one or more microdomains of at least one weak basic resin.

The microdomains are joined by covalent bonds, and, accordingly, the individual domains cannot be separated from one another. Each multicomponent SAP particle, therefore, is monolithic in nature.

The properties demonstrated by such preferred multicomponent SAP particles are unexpected because, in ion exchange applications, the combination of a weak acid and a weak base is the least effective of any combination of a strong or weak acid ion exchange resin with a strong or weak basic ion exchange resin. Accordingly, one aspect of the present invention is to provide SAP particles that have a high absorption rate, have good permeability and gel strength, overcome the salt poisoning effect, and demonstrate an improved ability to absorb and retain electrolyte-containing liquids, such as saline, blood, urine, and menses. The present monolithic SAP particles contain discrete microdomains of acidic resin and basic resin, which are covalently bound utilizing an interfacial crosslinking agent, and during hydration, the particles resist coalescence but remain fluid permeable.

Another aspect of the present invention is to provide an SAP having improved absorption and retention properties compared to a conventional SAP, such as sodium polyacrylate. The present multicomponent SAP particles are produced by any method that positions a microdomain of an acidic water-absorbing resin in contact with a microdomain of a basic water-absorbing resin to provide a discrete particle, followed by forming covalent bonds between the acidic resin and basic resin at microdomain interfaces utilizing an interfacial crosslinking agent.

In one embodiment, the present SAP particles are produced by coextruding (a) an acidic water-absorbing hydrogel containing an interfacial crosslinking agent in monomeric form and (b) a basic water-absorbing hydrogel to provide multicomponent SAP particles having a plurality of discrete microdomains of an acidic resin and a basic resin dispersed throughout the particle, followed by heating the SAP particle for a sufficient time at a sufficient temperature to covalently link the acidic resin and basic resin at microdomain interfaces through the interfacial crosslinking agent.

The resulting multicomponent SAP particles are monolithic. As used herein, the term “Imonolithic” is defined as an SAP particle having at least one microdomain of an acidic resin and at least one microdomain of a basic resin that cannot be separated into individual microdomains due to covalent bonds formed at the interface between the microdomains of the acidic and basic resins. Such monolithic, multicomponent SAP particles demonstrate improved absorption and retention properties, and improved permeability through and between particles compared to SAP compositions comprising a simple admixture of acidic resin particles and basic resin particles.

In another embodiment, the present monolithic, multicomponent SAP particles can be prepared by admixing dry particles of a basic resin with a hydrogel of an acidic resin containing a monomeric interfacial crosslinking agent, then extruding the resulting mixture to form multicomponent SAP particles having microdomains of a basic resin dispersed throughout a continuous phase of an acidic resin, followed by heating, i.e., curing, the SAP particles.

In addition, a monolithic, multicomponent SAP particle containing microdomains of an acidic resin and a basic resin dispersed in a continuous phase of a matrix resin can be prepared by adding dry particles of the acidic resin and dry particles of the basic resin to a hydrogel of the matrix hydrogel containing a monomeric interfacial crosslinking agent, then extruding and heating. Other forms of the present multicomponent SAP particles, such as agglomerated particles, interpenetrating polymer network forms, laminar forms, and concentric sphere forms, also demonstrate improved fluid absorption and retention properties.

In other important embodiments, the acidic and basic water-absorbing hydrogels are coextruded, or spun, in the presence of an interfacial crosslinking agent, to form a fiber having a core-sheath configuration. Alternatively, the acidic and basic water-absorbing hydrogels are extruded, or spun, individually, then twisted together, in the form of a braid, in the presence of an interfacial crosslinking agent, to provide a multicomponent SAP fiber. The fibers then are heat treated, i.e., cured, to form covalent bonds at interfaces between the acidic and basic resins.

In accordance with yet another important aspect of the present invention, the acidic and basic resins are lightly crosslinked utilizing an internal crosslinking agent, such as with a suitable polyfunctional vinyl polymer.

Yet another important feature of the present invention is to provide an SAP particle containing at least one microdomain of a weak acidic water-absorbing resin covalently bound to at least one microdomain of a weak basic water-absorbing resin utilizing an interfacial crosslinking agent.

An example of a weak acidic resin is polyacrylic acid having 0% to 60% neutralized carboxylic acid groups (i.e., DN=0 to DN=60). Examples of weak basic water-absorbing resins are a poly(vinylamine) and a polyethylenimine. Examples of a strong basic water-absorbing resin are poly(vinylguanidine) and poly(allylguanidine).

Yet another aspect of the present invention is to provide an improved SAP material comprising a combination containing (a) monolithic, multicomponent SAP particles, and (b) particles of a second water-absorbing resin selected from the group consisting of an acidic water-absorbing resin, a basic water-absorbing resin, and a mixture thereof. The combination contains about 10% to about 90%, by weight, monolithic, multicomponent SAP particles and about 10% to about 90%, by weight, particles of the second water-absorbing resin.

Still another aspect of the present invention is to provide articles of manufacture, like diapers and catamenial devices, having a core comprising monolithic, multicomponent SAP particles or an SAP material of the present invention. Other articles that can contain the monolithic, multicomponent SAP fibers or an SAP material of the present invention include adult incontinence products, and devices for absorbing saline and other ion-containing fluids.

These and other aspects and advantages of the present invention will become apparent from the following detailed description of the preferred embodiments.

### BRIEF DESCRIPTION OF THE DRAWINGS

FIG. 1 is a schematic diagram of a water-absorbing particle containing microdomains of a first resin dispersed in, and covalently bound to, a continuous phase of a second resin;

FIG. 2 is a schematic diagram of a water-absorbing particle containing microdomains of a first resin covalently bound to microdomains of a second resin dispersed throughout the particle;

FIGS. 3A and 3B are schematic diagrams of a water-absorbing particle having a core microdomain of a first resin surrounded by, and covalently bound to, a layer of a second resin;

FIGS. 4A-D are schematic diagrams of water-absorbing particles having a microdomain of a first resin covalently bound to a microdomain of a second resin;

FIGS. 5A and 5B are schematic diagrams of a water-absorbing particle having an interpenetrating network of a first resin covalently bound to a second resin; and

FIGS. 6A and 6B are schematic diagrams of a water-absorbing fiber having individual fibers of a first and a second water-absorbing resin twisted together to form a rope and joined by covalent bonds.

### DETAILED DESCRIPTION OF THE PREFERRED EMBODIMENTS

The present invention is directed to monolithic, multicomponent SAP particles containing at least one microdomain of an acidic water-absorbing resin covalently bound to at least one microdomain of a basic water-absorbing resin utilizing an interfacial crosslinking agent. Each particle contains one or more microdomains of an acidic resin and one or more microdomains of a basic resin. The microdomains can be distributed nonhomogeneously or homogeneously throughout each particle.

Each multicomponent SAP particle of the present invention contains at least one acidic water-absorbing resin and at least one basic water-absorbing resin. In one embodiment, the SAP particles consist essentially of acidic resins and basic resins, and contain microdomains of the acidic and/or basic resins. In another embodiment, the SAP particles further contain an absorbent matrix resin. In each embodiment, the microdomains of acidic resin are covalently linked to the microdomains of basic resin at microdomain interfaces by an interfacial crosslinking agent.

The multicomponent SAP particles of the present invention are not limited to a particular structure or shape. However, it is important that substantially each SAP particle contain at least one microdomain of an acidic water-absorbing resin and at least one microdomain of a basic water-absorbing resin covalently bound to one another. Improved water absorption and retention, and improved fluid permeability through and between SAP particles, are observed when the acidic resin microdomain and the basic resin microdomain are bound covalently to one another at microdomain interfaces via an interfacial crosslinking agent.

In some embodiments, an idealized monolithic, multicomponent SAP particle of the present invention is analogous to a liquid emulsion wherein small droplets of a first liquid, i.e., the dispersed phase, are dispersed in a second liquid, i.e., the continuous phase. The first and second liquids are immiscible, and the first liquid, therefore, is homogeneously dispersed in the second liquid. The first liquid can be water or oil based, and conversely, the second liquid is oil or water based, respectively.

Therefore, in one embodiment, the multicomponent SAP particles of the present invention can be envisioned as one or more microdomains of an acidic resin dispersed in a continuous phase of a basic resin, or as one or more microdomains of a basic resin dispersed in a continuous acid resin. These idealized multicomponent SAP particles are illustrated in FIG. 1 showing an SAP particle 10 having discrete microdomains 14 of a dispersed resin in a continuous phase of a second resin 12. Covalent bonds are present at interfaces 16 of each microdomain 14 and second resin 12. If microdomains 14 comprise an acidic resin, then continuous phase 12 comprises a basic resin. Conversely, if microdomains 14 comprise a basic resin, then continuous phase 12 is an acidic resin.

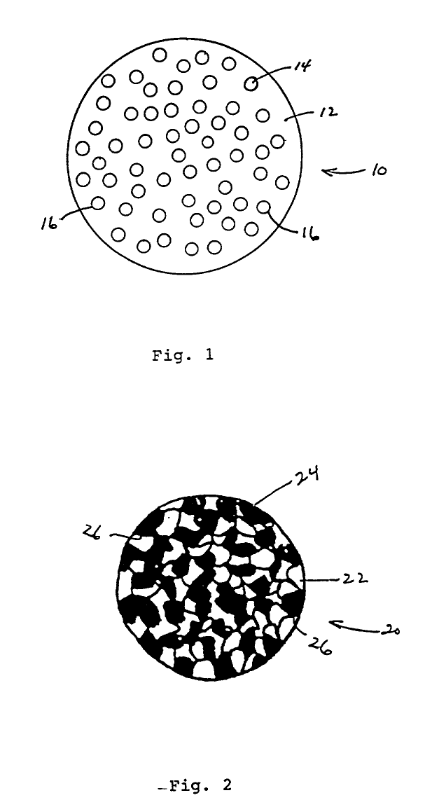

In another embodiment, the SAP particles are envisioned as microdomains of an acidic resin and microdomains of a basic resin dispersed throughout each particle, without a continuous phase, and covalently bound to one another. This embodiment is illustrated in FIG. 2, showing an idealized monolithic, multicomponent SAP particle 20 having a plurality of microdomains of an acidic resin 22 and a plurality of microdomains of a basic resin 24 dispersed throughout particle 20. Microdomains 22 are covalently bound to microdomains 24 at microdomain interfaces 26.

In yet another embodiment, a matrix resin is dispersed among microdomains of the acidic and basic resins. This embodiment also is illustrated in FIG. 1, for example, wherein multicomponent SAP particle 1C contains one or more microdomains 14, each an acidic resin or a matrix resin, dispersed in a continuous phase 12 of a basic resin. The microdomains of matrix resin can be covalently bound to the matrix resin, but covalent bonding is not essential.

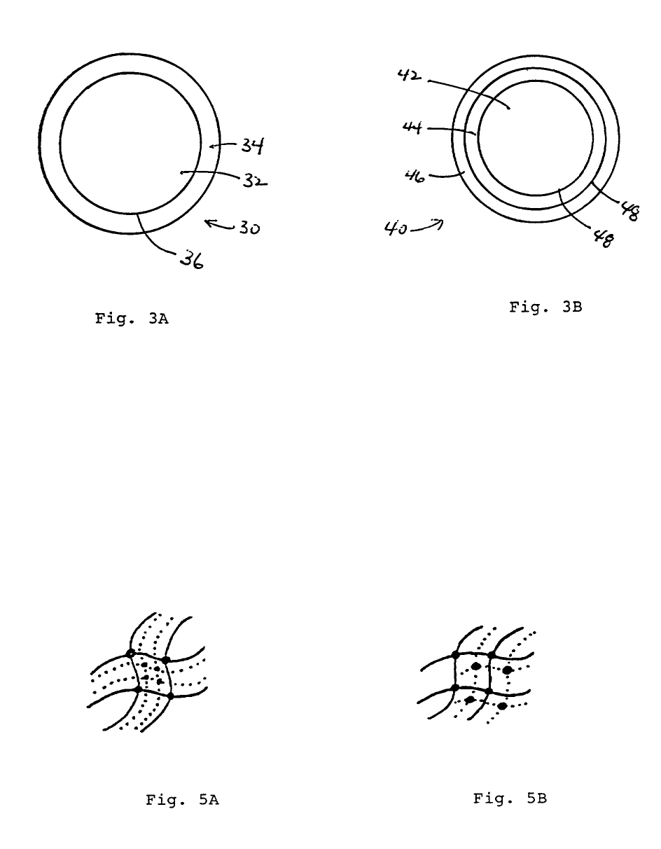

It should be understood that the microdomains within each particle can be of regular or irregular shape, and that the microdomains can be dispersed homogeneously or nonhomogeneously throughout each particle. Accordingly, another embodiment of the SAP particles is illustrated in FIG. 3A, showing an idealized monolithic, multicomponent particle 30 having a core 32 of an acidic water-absorbing resin surrounded by a shell 34 of a basic water-absorbing resin. Conversely, core 32 can comprise a basic resin, and shell 34 can comprise an acidic resin. Core 32 is covalently bound to shell 34 at core-shell interface 36.

FIG. 3B illustrates a similar embodiment having a core and concentric shells that alternate between shells of acidic resin and basic resin. In one embodiment, core 42 and shell 46 comprise an acidic water-absorbing resin, and shell 44 comprises a basic water-absorbing resin. Other embodiments include: core 42 and shell 46 comprising a basic resin and shell 44 comprising an acidic resin, or core 42 comprising a matrix resin and shells 44 and 46 comprising an acidic resin and a basic resin in alternating shells. Covalent bonds are formed between core 42 and shells 44 and 46 at interfaces 48. Other configurations are apparent to persons skilled in the art, such as increasing the number of shells around the core.

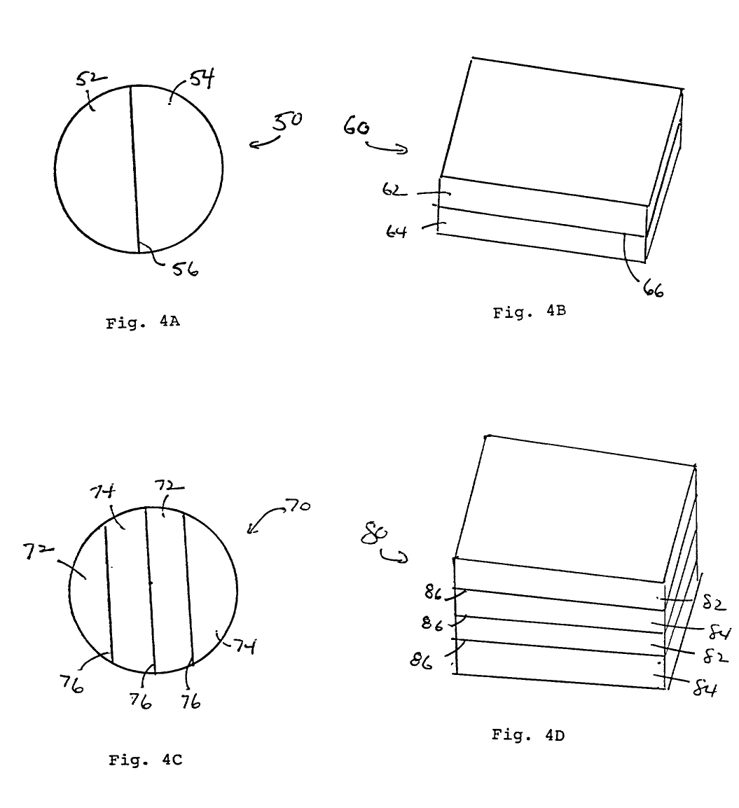

FIGS. 4A and 4B illustrate embodiments of the present SAP particles wherein one microdomain of an acidic water-absorbing resin (i.e., 52 or 62) is covalently bound to one microdomain of a basic water-absorbing resin (i.e., 54 or 64) at an interface (i.e., 56 or 66) to provide a monolithic, multicomponent SAP particle (i.e., 50 or 60). In these embodiments, the microdomains are dispersed nonhomogeneously throughout the particle. The embodiments illustrated in FIG. 4 extend to SAP particles having more than one microdomain of each of the acidic resin and the basic resin, as illustrated in FIGS. 4C and 4D, wherein monolithic, multicomponent SAP particles 70 and 80 contain alternating zones of acidic water-absorbing resin (e.g., 72 or 82) and basic water-absorbing resin (e.g., 74 or 84) covalent bound at interfaces 76 or 86. Particles 70 and 80 also can contain one or more layers 72, 74, 82, or 84 comprising a matrix resin.

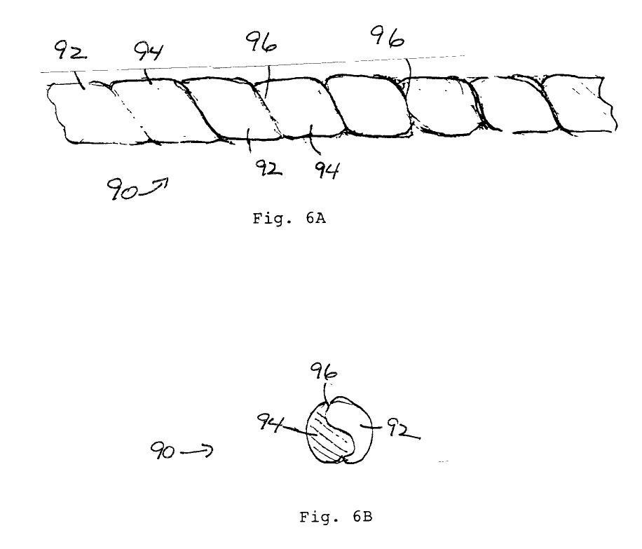

In another embodiment, the multicomponent SAP particle comprises an interpenetrating polymer network (IPN), as illustrated in FIG. 5. An IPN is a material containing two polymers, each in network form. In an IPN, two polymers are synthesized and/or crosslinked in the presence of one another, and polymerization can be sequential or simultaneous. Preparation of a sequential IPN begins with the synthesis of a first crosslinked polymer. Then, monomers comprising a second polymer, a crosslinker, and initiator are swollen into the first polymer, and polymerized and crosslinked in situ. For example, a crosslinked poly(acrylic acid) network can be infused with a solution containing a poly(vinylamine) and a crosslinker.

Simultaneous IPNs are prepared using a solution containing monomers of both polymers and their respective crosslinkers, which then are polymerized simultaneously by noninterfering modes, such as stepwise or chain polymerizations. A third method of synthesizing IPNs utilizes two lattices of linear polymers, mixing and coagulating the lattices, and crosslinking the two components simultaneously. Persons skilled in the art are aware of other ways that an IPN can be prepared, each yielding a particular topology.

In most IPNs, the polymer phases separate to form distinct zones of the first polymer and distinct zones of the second polymer. In the IPNS, the first and second polymers remain “soluble” in one another. Both forms of IPN have microdomains, and are multicomponent SAPs of the present invention. Covalent bonds are formed at the interfaces of the distinct zones of first and second polymers.

FIGS. 5A and 5B illustrate IPN systems. FIG. 5A illustrates an IPN made by sequentially synthesizing the first and second polymers. FIG. 5B illustrates an IPN made by simultaneously polymerizing the first and second polymers. In FIGS. 5A and 5B, the solid lines represent the first polymer (e.g., the acidic polymer) and the lightly dotted lines represent the second polymer (e.g., the basic polymer). The heavy dots represent crosslinking sites.

In another embodiment, the multicomponent SAP fiber comprises individual filaments of acidic resin and basic resin that are twisted together in the form of a rope. This embodiment is illustrated in FIGS. 6A and B, which illustrate a “twisted rope” embodiment of the present SAP fibers lengthwise and in cross section, respectively. In FIGS. 6A and B, a multicomponent SAP particle 90 comprises a filament 92 of acidic water-absorbing resin and a filament 94 of basic water-absorbing resin. In general, particle 90 can contain one or a plurality of filaments 92 or 94. Filaments 92 and 94 are in contact along zone of contact 96, thereby placing the acidic and basic resins in contact. Covalent bonds are formed along zone of contact 96.

The “twisted rope” SAP fibers of FIGS. 6A and B also can be an embodiment wherein acidic resin filament 92 contains microdomains of a basic water-absorbing resin, i.e., is a multicomponent SAP fiber itself, and/or basic resin filament 94 contains microdomains of an acidic water-absorbing resin, i.e., also is a multicomponent SAP fiber itself. Filaments 92 and 94 then are intertwined to form multicomponent SAP fiber 90.

The embodiment of FIGS. 6A and B also can be a filament 92 and/or a filament 94 comprising a matrix resin having microdomains of acidic resin and/or basic resin. In this embodiment, filament 92 contains microdomains of an acidic resin, or microdomains of an acidic and a basic resin, and filament 94 contains microdomains of a basic resin, or microdomains of an acidic resin and a basic resin.

In another embodiment, the multicomponent SAP particles are agglomerated particles prepared from fine particles of an acidic water-absorbing resin and fine particles of a basic water-absorbing resin. Typically, a fine resin particle has a diameter of less than about 200 microns (μ), such as about 0.01 to about 180μ. The agglomerated multicomponent SAP particles are similar in structure to the particle depicted in FIG. 2. With respect to the agglomerated SAP particles, the number of covalent bonds between the acidic resin and basic resin particles is sufficient such that the particles have sufficient dry agglomeration (i.e., in the dry state) and wet agglomeration (i.e., in the hydrogel state) to retain single particle properties, i.e., the particles do not disintegrate into their constituent fine particles of acidic resin and basic resin.

In particular, the agglomerated particles have sufficient dry agglomeration to withstand fracturing. The dry agglomerated particles typically have an elastic character and, therefore, are not friable. The agglomerated particles also have sufficient wet strength to exhibit a property termed “wet agglomeration.” Wet agglomeration is defined as the ability of an agglomerated multicomponent SAP particle to retain its single particle nature upon hydration, i.e., a lack of deagglomeration upon hydration. Wet agglomeration is determined by positioning fifty agglomerated SAP particles on a watch glass and hydrating the particles with 20 times their weight of a 1% (by weight) sodium chloride solution (i.e., 1% saline). The particles are spaced sufficiently apart such that they do not contact one another after absorbing the saline and swelling. The SAP particles are allowed to absorb the saline solution for one hour, then the number of SAP particles is recounted under a microscope. The multicomponent SAP particles pass the wet agglomeration test if no more than about 53 hydrated particles are counted.

The monolithic, multicomponent SAP particles of the present invention therefore comprise an acidic resin and a basic resin in a mole ratio of about 95:5 to about 5:95, and preferably about 85:15 to about 15:85. To achieve the full advantage of the present invention, the mole ratio of acidic resin to basic resin in a multicomponent SAP particle is about 30:70 to about 70:30. The acidic and basic resins can be distributed homogeneously or nonhomogeneously throughout the SAP particle.

The present monolithic, multicomponent SAP particles contain at least about 50%, and preferably at least about 70%, by weight of acidic resin plus basic resin. To achieve the full advantage of the present invention, a multicomponent SAP particle contains about 80% to 100% by weight of the acidic resin plus basic resin. Components of the present SAP particles, other than the acidic and basic resin, typically, are matrix resins or other minor optional ingredients.

The monolithic, multicomponent SAP particles of the present invention can be in any form, either regular or irregular, such as granules, fibers, beads, powders, flakes, or foams, or any other desired shape, such as a sheet of the multicomponent SAP. In embodiments wherein the multicomponent SAP is prepared using an extrusion step, the shape of the SAP is determined by the shape of the extrusion die. The shape of the multicomponent SAP particles also can be determined by other physical operations, such as milling or by the method of preparing the particles, such as agglomeration.

In one preferred embodiment, the present SAP particles are in the form of a granule or a bead, having a particle size of about 10 to about 10,000 microns (μm), and preferably about 100 to about 1,000 μm. To achieve the full advantage of the present invention, the multicomponent SAP particles have a particle size of about 150 to about 800 μm.

A “microdomain” is defined as a volume of an acidic resin or a basic resin that is present in a multicomponent SAP particle. Because each multicomponent SAP particle contains at least one microdomain of an acidic resin, and at least one microdomain of a basic resin, a microdomain has a volume that is less than the volume of the multicomponent SAP particle. A microdomain, therefore, can be as large as about 90% of the volume of multicomponent SAP particles.

Typically, a microdomain has a diameter of about 750 μm or less, and preferably about 100 μm or less. To achieve the full advantage of the present invention, a microdomain has a diameter of about 20 μm or less. The multicomponent SAP particles also contain microdomains that have submicron diameters, e.g., microdomain diameters of less than 1 μm, preferably less than 0.1 μm, to about 0.01 μm. A microdomain also can be the entire filament of a twisted rope form of a multicomponent SAP fiber.

In another preferred embodiment, the multicomponent SAP particles are in the shape of a fiber, i.e., an elongated, acicular SAP particle. The fiber can be in the shape of a cylinder, for example, having a minor dimension (i.e., diameter) and a major dimension (i.e., length). The fiber also can be in the form of a long filament that can be woven. Such filament-like fibers have a weight of below about 80 decitex, and preferably below about 70 decitex, per filament, for example, about 2 to about 60 decitex per filament. Tex is the weight in grams per one kilometer of fiber. One tex equals 10 decitex. For comparison, poly(acrylic acid) is about 0.78 decitex (0.078 tex), and poly(vinylamine) is about 6.1 decitex (0.61 decitex).

Cylindrical multicomponent SAP fibers have a minor dimension (i.e., diameter of the fiber) less than about 1 mm, usually less than about 500 μm, and preferably less than 250 μm, down to about 10 μm. The cylindrical SAP fibers can have a relatively short major dimension, for example, about 1 mm, e.g., in a fibrid, lamella, or flake-shaped article, but generally the fiber has a length of about 3 to about 100 mm. The filament-like fibers have a ratio of major dimension to minor dimension of at least 500 to 1, and preferably at least 1000 to 1, for example, up to and greater than 10,000 to 1.

Each multicomponent SAP particle contains one or more microdomains of an acidic water-absorbing resin and one or more microdomains of a basic water-absorbing resin, which are covalently bound to one another utilizing an interfacial crosslinking agent. As illustrated hereafter, the microdomain structure of the present SAP particles provides improved fluid absorption (both in amount of fluid absorbed and retained, and rate of absorption) compared to (a) an SAP comprising a simple mixture of discrete acidic SAP resin particles and discrete basic SAP resin particles, and (b) an annealed multicomponent SAP particle lacking covalent linkages between the microdomain interfaces provided by an interfacial crosslinking agent.

In accordance with another important feature of the present invention, the present monolithic, multicomponent SAP particles also demonstrate improved permeability, both through an individual particle and between particles. The present SAP particles, therefore, have an improved ability to rapidly absorb a fluid, even in “gush” situations, for example, when used in diapers to absorb urine.

The features of good permeability, absorption and retention properties, especially of electrolyte-containing liquids, demonstrated by the present monolithic, multicomponent SAP particles, is important with respect to practical uses of an SAP. These improved properties are attributed, in part, to the fact that electrolyte removal from the liquid is facilitated by contacting a single particle (which, in effect, performs an essentially simultaneous deionization of the liquid), as opposed to the liquid having to contact individual acidic and basic particles (which, in effect, performs a sequential two-step deionization).

If a blend of acidic resin particles and basic resin particles is used, the particles typically have a small particle size. A small particle size is required to obtain desirable desalination kinetics, because the electrolyte is removed in a stepwise manner, with the acidic resin removing the cation and the basic resin removing the anion. The electrolyte-containing fluid, therefore, must contact two particles for desalination, and this process is facilitated by small particle sized SAPs. Small particles, however, have the effect of reducing flow of the fluid through and between SAP particles, i.e., permeability is reduced and a longer time is required to absorb the fluid.

In addition, in practical use, such as in diapers, SAPs are used in conjunction with a cellulosic pulp. If a blend of acidic resin particles and basic resin particles is used as the SAP, the cellulosic pulp can cause a separation between the acidic resin particles and basic resin particles, which adversely affects desalination. The present monolithic, multidomain composites overcome this problem because the acidic resin and basic resin are present in a single particle and the domains of acidic resin and basic resin are covalently bound to another. The introduction of cellulosic pulp, therefore, cannot separate the acidic and basic resin and cannot adversely affect desalination by the SAP.

A single, monolithic, multicomponent SAP particle simultaneously desalinates an electrolyte-containing liquid. Desalination is essentially independent of particle size. Accordingly, the present multicomponent SAP particles can be of a larger size. These features allow for improved liquid permeability through and between the SAP particles, and results in a more rapid absorption of the electrolyte-containing liquid.

The following schematic reactions illustrate the reactions which occur to deionize, e.g., desalinate, an aqueous saline solution, and that are performed essentially simultaneously in a single microcomposite SAP particle, but are performed step-wise in a simple mixture of acidic and basic resins:

R—CO₂H+NaCl→R—CO₂⁻Na⁺+HCl

(acidic resin)

R—NH₂+HCl R→NH₃+Cl⁻

(basic resin).

The present monolithic, multicomponent SAP particles can be in a form wherein a microdomain of an acidic water-absorbing resin is in contact with, and covalently bound via an interfacial crosslinking agent to, a microdomain of a basic water-absorbing resin. In another embodiment, the SAP particles can be in a form wherein at least one microdomain of an acidic water-absorbing resin is dispersed in, and covalently bound to, a continuous phase of a basic water-absorbing resin. Alternatively, the multicomponent SAP can be in a form wherein at least one microdomain of a basic resin is dispersed in, and covalently bound to, a continuous phase of an acidic resin. In another embodiment, at least one microdomain of one or more acidic resin and at least one microdomain of one or more basic resin are covalently bound to one another and comprise the entire SAP particle, and neither type of resin is considered the dispersed or the continuous phase. In yet another embodiment, at least one microdomain of an acidic resin and at least one microdomain of a basic resin are covalently bound in the presence of a matrix resin.

An acidic water-absorbing resin present in a monolithic, multicomponent SAP particle can be either a strong or a weak acidic water-absorbing resin. The acidic water-absorbing resin can be a single resin, or a mixture of resins. The acidic resin can be a homopolymer or a copolymer. The identity of the acidic water-absorbing resin is not limited as long as the resin is capable of swelling and absorbing at least ten times its weight in water, when in a neutralized form. The acidic resin is present in its acidic form, i.e., about 40% to 100%, preferably about 50% to 100%, and most preferably about 75% to 100%, of the acidic moieties are present in the free acid form. As illustrated hereafter, although the free acid form of a acidic water-absorbing resin is generally a poor water absorbent, the combination of an acidic resin and a basic resin in a present multicomponent SAP particle provides excellent water absorption and retention properties.

The acidic water-absorbing resin typically is a lightly crosslinked acrylic-type resin, such as lightly crosslinked poly(acrylic acid). The lightly crosslinked acidic resin typically is prepared by polymerizing an acidic monomer containing an acyl moiety, e.g., acrylic acid, or a moiety capable of providing an acid group, i.e., acrylonitrile, in the presence of a crosslinker, i.e., a polyfunctional organic compound. The acidic resin can contain other copolymerizable units, i.e., other monoethylenically unsaturated comonomers, well known in the art, as long as the polymer is substantially, i.e., at least 10%, and preferably at least 25%, acidic monomer units. To achieve the full advantage of the present invention, the acidic resin contains at least 50%, and more preferably, at least 75%, and up to 100%, acidic monomer units. The other copolymerizable units can, for example, help improve the hydrophilicity of the polymer.

Ethylenically unsaturated carboxylic acid and carboxylic acid anhydride monomers useful in the acidic water-absorbing resin include, but are not limited to, acrylic acid, methacrylic acid, ethacrylic acid, α-chloroacrylic acid, α-cyanoacrylic acid, β-methylacrylic acid (crotonic acid), α-phenylacrylic acid, β-acryloxypropionic acid, sorbic acid, α-chlorosorbic acid, angelic acid, cinnamic acid, p-chlorocinnamic acid, β-stearylacrylic acid, itaconic acid, citraconic acid, mesaconic acid, glutaconic acid, aconitic acid, maleic acid, furmaric acid, tricarboxyethylene, and maleic anhydride.

Ethylenically unsaturated sulfonic acid monomers include, but are not limited to, aliphatic or aromatic vinyl sulfonic acids, such as vinylsulfonic acid, allyl sulfonic acid, vinyl toluene sulfonic acid, styrene sulfonic acid, acrylic and methacrylic sulfonic acids, such as sulfoethyl acrylate, sulfoethyl methacrylate, sulfopropyl acrylate, sulfopropyl methacrylate, 2-hydroxy-3-methacryloxypropyl sulfonic acid, and 2-acrylamide-2-methylpropane sulfonic acid.

As set forth above, polymerization of acidic monomers, and copolymerizable monomers, if present, most commonly is performed by free radical processes in the presence of a polyfunctional organic compound. The acidic resins are internally crosslinked to a sufficient extent such that the polymer is water insoluble. Internal crosslinking renders the acidic resins substantially water insoluble, and, in part, serves to determine the absorption capacity of the resins. For use in absorption applications, an acidic resin is lightly crosslinked, i.e., has a crosslinking density of less than about 20%, preferably less than about 10%, and most preferably about 0.01% to about 7%.

An internal crosslinking agent most preferably is used in an amount of less than about 7 wt %, and typically about 0.1 wt % to about 5 wt %, based on the total weight of monomers. Examples of internal crosslinking polyvinyl monomers include, but are not limited to, polyacrylic (or polymethacrylic) acid esters, represented by the following formula (I), and bisacrylamides, represented by the following formula (II),

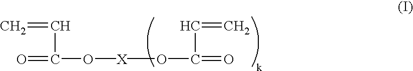

wherein x is ethylene, propylene, trimethylene, cyclohexyl, hexamethylene, 2-hydroxypropylene, —(CH₂CH₂O)ₙCH₂CH₂—, or

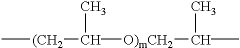

n and m are each an integer 5 to 40, and k is 1 or 2;

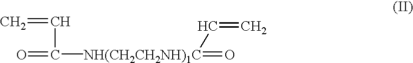

wherein 1 is 2 or 3.

The compounds of formula (I) are prepared by reacting polyols, such as ethylene glycol, propylene glycol, trimethylolpropane, 1,6-hexanediol, glycerin, pentaerythritol, polyethylene glycol, or polypropylene glycol, with acrylic acid or methacrylic acid. The compounds of formula (II) are obtained by reacting polyalkylene polyamines, such as diethylenetriamine and triethylenetetramine, with acrylic acid.

Specific internal crosslinking monomers include, but are not limited to, 1,4-butanediol diacrylate, 1,4-butanediol dimethacrylate, 1,3-butylene glycol diacrylate, 1,3-butylene glycol dimethacrylate, diethylene glycol diacrylate, diethylene glycol dimethacrylate, ethoxylated bisphenol A diacrylate, ethoxylated bisphenol A dimethacrylate, ethylene glycol dimethacrylate, 1,6-hexanediol diacrylate, 1,6-hexanediol dimethacrylate, neopentyl glycol dimethacrylate, polyethylene glycol diacrylate, polyethylene glycol dimethacrylate, triethylene glycol diacrylate, triethylene glycol dimethacrylate, tripropylene glycol diacrylate, tetraethylene glycol diacrylate, tetraethylene glycol dimethacrylate, dipentaerythritol pentaacrylate, pentaerythritol tetraacrylate, pentaerythritol triacrylate, trimethylolpropane triacrylate, trimethylolpropane trimethacrylate, tris(2-hydroxyethyl)isocyanurate triacrylate, tris(2-hydroxyethyl)isocyanurate trimethacrylate, divinyl esters of a polycarboxylic acid, diallyl esters of a polycarboxylic acid, triallyl terephthalate, diallyl maleate, diallyl fumarate, hexamethylenebismaleimide, trivinyl trimellitate, divinyl adipate, diallyl succinate, a divinyl ether of ethylene glycol, cyclopentadiene diacrylate, tetraallyl ammonium halides, or mixtures thereof. Compounds such as divinylbenzene and divinyl ether also can be used as crosslinkers. Especially preferred crosslinking agents are N,N′-methylenebisacrylamide, N,N′-methylenebismethacrylamide, ethylene glycol dimethacrylate, and trimethylolpropane triacrylate.

The acidic resin, either strongly acidic or weakly acidic, can be any resin that acts as an SAP in its neutralized form. The acidic resins typically contain a plurality of carboxylic acid, sulfonic acid, phosphonic acid, phosphoric acid, and/or sulfuric acid moieties. Examples of acidic resins include, but are not limited to, polyacrylic acid, hydrolyzed starch-acrylonitrile graft copolymers, starch-acrylic acid graft copolymers, saponified vinyl acetate-acrylic ester copolymers, hydrolyzed acrylonitrile copolymers, hydrolyzed acrylamide copolymers, ethylene-maleic anhydride copolymers, isobutylene-maleic anhydride copolymers, poly(vinylsulfonic acid), poly(vinylphosphonic acid), poly(vinylphosphoric acid), poly(vinylsulfuric acid), sulfonated polystyrene, poly(aspartic acid), poly(lactic acid), and mixtures thereof. The preferred acidic resins are the poly(acrylic acids).

The monolithic, multicomponent SAPs can contain individual microdomains that: (a) contain a single acidic resin or (b) contain more than one, i.e., a mixture, of acidic resins. The multicomponent SAPs also can contain microdomains wherein, for the acidic component, a portion of the acidic microdomains comprise a first acidic resin or acidic resin mixture, and the remaining portion comprises a second acidic resin or acidic resin mixture.

Analogous to the acidic resin, the basic water-absorbing resin in the present monolithic SAP particles can be a strong or weak basic water-absorbing resins. The basic water-absorbing resin can be a single resin or a mixture of resins. The basic resin can be a homopolymer or a copolymer. The basic resin is capable of swelling and absorbing at least 10 times its weight in water, when in a charged form. The weak basic resin typically is present in its free base, or neutral, form, i.e., about 60% to 100%, and preferably about 75% to 100% of the basic moieties, e.g., amino groups, are present in a neutral, uncharged form. The strong basic resins typically are present in the hydroxide (OH) or bicarbonate (HCO₃) form.

The basic water-absorbing resin typically is a lightly crosslinked resin, such as a poly(vinylamine). The basic water-absorbing resin can be any polymer containing a primary amine, a secondary amine, or a hydroxy functionality. The basic resin also can be a polymer, such as a lightly crosslinked polyethylenimine, a poly(allylamine), a poly(diallylamine), a copolymer of a dialkylamino acrylate and a monomer having primary amino, secondary amino, or hydroxy functionality, a guanidine-modified polystyrene, such as

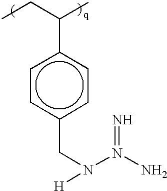

or a poly(vinylguanidine), i.e., poly(VG), a strong basic water-absorbing resin having the general structural formula (III)

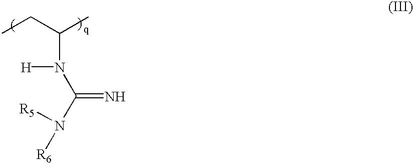

wherein q is a number from 10 to about 100,000, and R₅ and R₆, independently, are selected from the group consisting of hydrogen, C₁-C₄ alkyl, C₁-C₆ cycloalkyl, benzyl, phenyl, alkyl-substituted phenyl, naphthyl, and similar aliphatic and aromatic groups. The lightly crosslinked basic water-absorbing resin can contain other copolymerizable units and is crosslinked using a polyfunctional organic compound, as set forth above with respect to the acidic water-absorbing resin.

A basic water-absorbing resin used in the present SAP particles typically contains an amino or a guanidino group. Accordingly, a water-soluble basic resin also can be internally crosslinked in solution by suspending or dissolving an uncrosslinked basic resin in an aqueous or alcoholic medium, then adding a di- or polyfunctional compound capable of crosslinking the basic resin by reaction with the amino groups of the basic resin. Such internal crosslinking agents include, for example, multifunctional aldehydes (e.g., glutaraldehyde), multifunctional acrylates (e.g., butanediol diacrylate, TMPTA), halohydrins (e.g., epichlorohydrin), dihalides (e.g., dibromopropane), disulfonate esters (e.g., ZA(O₂)O—(CH₂)ₙ—OS(O)₂Z, wherein n is 1 to 10, and Z is methyl or tosyl), multifunctional epoxies (e.g., ethylene glycol diglycidyl ether), multifunctional esters (e.g., dimethyl adipate), multifunctional acid halides (e.g., oxalyl chloride), multifunctional carboxylic acids (e.g., succinic acid), carboxylic acid anhydrides (e.g., succinic anhydride), organic titanates (e.g., TYZOR AA from DuPont), melamine resins (e.g., CYMEL 301, CYMEL 303, CYMEL 370, and CYMEL 373 from Cytec Industries, Wayne, N.J.), hydroxymethyl ureas (e.g., N,N′-dihydroxymethyl-4,5-dihydroxyethyleneurea), and multifunctional isocyanates (e.g., toluene diisocyanate or methylene diisocyanate). Crosslinking agents also are disclosed in Pinschmidt, Jr. et al. U.S. Pat. No. 5,085,787, incorporated herein by reference, and in EP 450 923.

Conventionally, the internal crosslinking agent is water or alcohol soluble, and possesses sufficient reactivity with the basic resin such that crosslinking occurs in a controlled fashion, preferably at a temperature of about 25° C. to about 150° C. Preferred internal crosslinking agents are ethylene glycol diglycidyl ether (EGDGE), a water-soluble diglycidyl ether, and a dibromoalkane, an alcohol-soluble compound.

The basic resin, either strongly or weakly basic, therefore, can be any resin that acts as an SAP in its charged form. The basic resin typically contains amino or guanidino moieties. Examples of basic resins include a poly(vinylamine), a polyethylenimine, a poly(vinylguanidine), a poly(allylamine), or a poly(allylguanidine). Preferred basic resins include a poly(vinylaminel, polyethylenimine, and poly(vinylguanadine). Analogous to microdomains of an acidic resin, the present monolithic, multicomponent SAPs can contain microdomains of a single basic resin, microdomains containing a mixture of basic resins, or microdomains of different basic resins.

The interfacial crosslinking agent can be any polyfunctional compound capable of interaction with the acidic moiety of the acidic resin and the basic moiety of the basic resin to form covalent bonds at the interface of the acidic resin microdomain and basic resin microdomain.

Nonlimiting examples of suitable interfacial crosslinking agents include, but are not limited to:

(a) multifunctional aziridines, such as 2,2-bishydroxymethyl butanol tris[3-(1-aziridine propionate]);

(b) halohydrins, such as epichlorohydrin;

(c) multifunctional epoxy compounds, for example, ethylene glycol diglycidyl ether, bisphenol A diglycidyl ether, and bisphenol F diglycidyl ether;

(d) multifunctional carboxylic acids and esters, acid chlorides, and anhydrides derived therefrom, for example, di- and polycarboxylic acids containing 2 to 12 carbon atoms, and the methyl and ethyl esters, acid chlorides, and anhydrides derived therefrom, such as oxalic acid, adipic acid, succinic acid, dodecanoic acid, malonic acid, and glutaric acid, and esters, anhydrides, and acid chlorides derived therefrom;

(e) multifunctional isocyanates, such as toluene diisocyanate, isophorone diisocyanate, methylene diisocyanate, xylene diisocyanate, and hexamethylene diisocyanate;

(f) β-hydroxyalkylamides as disclosed in U.S. Pat. No. 4,076,917, incorporated herein by reference, such as PRIMID® XL-552, available from EMS-CHEMIE AG, Dornat, Switzerland;

(g) an uncrosslinked polyamine, like a poly(vinylamine), a polyethylenimine (PEI), or a branched polyethylenimine (BPEI);

(h) a cyclic urethane as disclosed in WO 99/42494, WO 00/31152, and WO 00/31153, incorporated herein by reference, such as

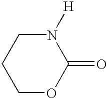

(i) an alkylene carbonate, such as ethylene carbonate or propylene carbonate; and

(j) other crosslinking agents for acidic and basic water-absorbing resins known to persons skilled in the art.

A preferred interfacial crosslinking agent is a multifunctional epoxy compound (e.g., ethylene glycol diglycidyl ether (EGDGE)), PRIMID® XL-552, or a mixture thereof, which crosslink an acidic and basic resin at a temperature of about 25° C. to about 150° C. Especially preferred interfacial crosslinking agents are EGDGE and PRIMID® XL-552.

The present monolithic, multicomponent SAPs can be prepared by various methods. It should be understood that the exact method of preparing a multicomponent SAP is not limited by the following embodiments. Any method that provides a particle having at least one microdomain of an acidic resin covalently linked to at least one microdomain of a basic resin through an interfacial crosslinking agent is suitable.

In one method, dry particles of a basic resin are admixed into a rubbery gel of an acidic resin further containing an interfacial crosslinking agent. The resulting mixture is extruded, then dried, and optionally surface crosslinked to provide multicomponent SAP particles having microdomains of a basic resin dispersed in, and covalently bound to, a continuous phase of an acidic resin via the interfacial crosslinking agent.

In another method, dry particles of an acidic resin can be admixed with dry particles of a basic resin and an interfacial crosslinking agent, and the resulting mixture is formed into a hydrogel, then extruded, and dried to form multicomponent SAP particles having acidic and basic microdomains covalently bound by the interfacial crosslinking agent.

In yet another method, a rubbery gel of an acidic resin and a rubbery gel of a basic resin, in the presence of an interfacial crosslinking agent, are coextruded, then the coextruded product is dried to form multicomponent SAP particles containing covalently bound microdomains of the acidic resin and the basic resin dispersed throughout the particle.

Another method utilizes spinning technology, wherein a first polymer, e.g., poly(vinylamine), is spun in the form of a filament, then the freshly spun filament is coated with a second polymer, e.g., poly(acrylic acid), and an interfacial crosslinking agent, to form (after drying) a core-sheath multicomponent SAP fiber. The fiber then is heated at a sufficient temperature for a sufficient time to form covalent bonds at the interface between the core and sheath.

The method of preparing the present multicomponent SAP particles is not limited, and does not require an extrusion step. Persons skilled in the art are aware of other methods of preparation wherein the multicomponent SAP contains at least one microdomain of an acidic resin and at least one microdomain of a basic resin covalently bound to one another. One example is agglomeration of fine particles of at least one acidic resin and at least one basic resin with each other and in the presence of an interfacial crosslinking agent, and optionally a matrix resin, followed by a heating step, to provide a multicomponent SAP particle containing microdomains of an acidic resin covalently bound to microdomains of a basic resin by the interfacial crosslinking agent. The multicomponent SAP particles can be ground to a desired particle size, or can be prepared by techniques that yield the desired particle size. Other nonlimiting methods of preparing an SAP particle of the present invention are set forth in the examples.

In embodiments wherein an acidic resin and a basic resin are present as microdomains within a matrix of a matrix resin, particles of an acidic resin and a basic resin, and an interfacial crosslinking agent, are admixed with a rubbery gel of a matrix resin, and the resulting mixture is extruded, then dried and heated to form monolithic, multicomponent SAP particles having microdomains of an acidic resin and a basic resin dispersed in a continuous phase of a matrix resin, and covalently bound to one another. Alternatively, rubbery gels of an acidic resin, basic resin, interfacial crosslinking agent, and matrix resin can be coextruded, then heated, to provide a multicomponent SAP containing covalently bound microdomains of an acidic resin, a basic resin, and a matrix resin dispersed throughout the particle.

The matrix resin is any resin that allows fluid transport such that a liquid medium can contact the acidic and basic resin. The matrix resin typically is a hydrophilic resin capable of absorbing water. Nonlimiting examples of matrix resins include poly(vinyl alcohol), poly(N-vinylformamide), polyethylene oxide, poly(meth)acrylamide, poly(hydroxyethyl acrylate), hydroxyethylcellulose, methylcellulose, and mixtures thereof. The matrix resin also can be a conventional water-absorbing resin, for example, a polyacrylic acid neutralized greater than 60 mole %, and typically greater than 65 mole %. The matrix resin can form covalent bonds with the acidic resin and/or basic resin via the interfacial crosslinking agent, or can be inert with respect to forming covalent bonds with the acidic and/or basic resin.

Surprisingly, the multicomponent SAP particles of the present invention exhibit excellent absorption and retention properties without the need to surface crosslink the particles. Conventional SAPs typically are surface crosslinked to improve absorption and retention properties. An added advantage of the present multicomponent SAP particles is to eliminate the costly and time-consuming step of surface crosslinking, without sacrificing SAP performance. It should be noted, however, that surface crosslinking is not necessary, but is not precluded.

In the case of an SAP particle containing poly(acrylic acid) as the acidic resin, poly(vinylamine) as the basic resin, EGDGE as the interfacial crosslinking agent, carboxyl groups of the poly(acrylic acid) and amino groups of the poly(vinylamine) are in close proximity to each other and to the interfacial crosslinking agent at each interface between the acidic resin and basic resin. Heating the multicomponent SAP particles for a sufficient time results in a reaction between the carboxyl groups and amino groups with the epoxy groups of EGDGE to form covalent interfacial bonds. These covalent bonds covalently link a microdomain of an acidic resin to a microdomain of a basic resin. These covalent interfacial bonds thereby render the multicomponent SAP particles monolithic, i.e., the acidic resin microdomains cannot be physically separated from the basic resin microdomains.

In preferred embodiments, the multicomponent SAP particles are heated to form interfacial crosslinks at a temperature greater than the glass transition temperature, i.e., the Tg, of at least one of the water-absorbing resins present in the SAP particles. Heating above the Tg of a resin comprising the multicomponent SAP particle facilitates the reaction which forms covalent crosslinking bonds at the resin interface of the particle.

When using EGDGE as the interfacial crosslinking agent, the acidic resin preferably is neutralized at least 10%, and typically about 10% to about 20%, to facilitate interfacial crosslinking. For other interfacial crosslinking agents, the acidic resin is readily interfacially crosslinked when 0% neutralized.

In accordance with an important feature of the present invention, a strong acidic resin can be used with either a strong basic resin or a weak basic resin, or a mixture thereof. A weak acidic resin can be used with a strong basic resin or a weak basic resin, or a mixture thereof. Preferably, the acidic resin is a weak acidic resin and the basic resin is a weak basic resin. This result is unexpected in view of the ion exchange art wherein a combination of a weak acidic resin and a weak basic resin does not perform as well as other combinations, e.g., a strong acidic resin and a strong basic resin.

As previously discussed, sodium poly(acrylate) conventionally is considered the best SAP, and, therefore, is the most widely used SAP in commercial applications. Sodium poly(acrylate) has polyelectrolytic properties that are responsible for its superi- or performance in absorbent applications. These properties include a high charge density, and charge relatively close to the polymer backbone.

However, an acidic resin in the free acid form, or a basic resin in the free base form, typically do not function as a commercially useful SAP because there is no ionic charge on either type of polymer. A poly(acrylic acid) resin, or a poly(vinylamine) resin, are neutral polymers, and, accordingly, do not possess the polyelectrolytic properties necessary to provide SAPs useful commercially in diapers, catamenial devices, and similar absorbent articles. The driving force for water absorption and retention, therefore, is lacking. This is illustrated in the relatively poor absorption and retention properties for a neutral polyacrylic acid, i.e., AUL (0.7 psi, 3 hours) of 10 g/g, a neutral poly(DAEA), i.e., AUL (0.7 psi, 3 hours) of 9.3 g/g, a neutral poly(vinylamine), i.e., AUL (0.7 psi, 3 hours) of 14.3 g/g, and a neutral poly(DMAPMA), i.e., AUL (0.7 psi, 3 hours) of 10 g/g in absorbing synthetic urine. However, when converted to a salt, an acidic resin, such as a polyacrylic acid, or a basic resin, such as a poly(dialkylaminoalkyl (meth)acrylamide), then behave as a commercially useful SAP, i.e., AUL (0.7 psi, 3 hours) of 20 g/g or more.

It has been found that basic resins, in their free base form, are useful components in superabsorbent materials further containing an acidic water-absorbing resin. For example, a superabsorbent material comprising an admixture of a poly(dialkylaminoalkyl (meth)acrylamide) and an acidic water-absorbing resin, such as poly(acrylic acid), demonstrates good water absorption and retention properties. Such an SAP material comprises two uncharged, slightly crosslinked polymers, each of which is capable of swelling and absorbing aqueous media. When contacted with water or an aqueous electrolyte-containing medium, the two uncharged polymers neutralize each other to form a superabsorbent material. This also reduces the electrolyte content of the medium absorbed by polymer, further enhancing the polyelectrolyte effect. Neither polymer in its uncharged form behaves as an SAP by itself when contacted with water. However, superabsorbent materials, which contain a simple mixture of two resins, one acidic and one basic, are capable of acting as an absorbent material because the two resins are converted to their polyelectrolyte form. These superabsorbent materials have demonstrated good water absorption and retention properties. However, the present multicomponent SAP particles, containing at least one microdomain of an acidic resin covalently bound via an interfacial crosslinking agent to at least one microdomain of a basic resin, exhibit improved water absorption and retention, and improved permeability, over simple mixtures of acidic resin particles and basic resin particles.

In the present multicomponent SAP particles, the weak basic resin is present in its free base, e.g., amine, form, and the acidic resin is present in its free acid form. It is envisioned that about 40% or less of the amine functionalities and about 60% or less of the acid functionalities can be in their charged form. The charged functionalities do not adversely affect performance of the SAP particles, and can assist in the formation of interfacial crosslinking and in the initial absorption of a liquid. A strong basic resin is present in the hydroxide or bicarbonate, i.e., charged, form.

The present multicomponent SAP particles are useful in articles designed to absorb large amounts of liquids, especially electrolyte-containing liquids, such as in diapers and catamenial devices.

The following nonlimiting examples illustrate the preparation of monolithic, multicomponent SAP particles of the present invention.

In the test results set forth below, the multicomponent SAP particles of the present invention were tested for absorption under no load (AUNL) and absorption under load at 0.28 psi and 0.7 psi (AUL (0.28 psi) and AUL (0.7 psi)). Absorption under load (AUL) is a measure of the ability of an SAP to absorb fluid under an applied pressure. The AUL was determined by the following method, as disclosed in U.S. Pat. No. 5,149,335, incorporated herein by reference.

An SAP (0.160 g+/−0.001 g) is carefully scattered onto a 140-micron, water-permeable mesh attached to the base of a hollow Plexiglas cylinder with an internal diameter of 25 mm. The sample is covered with a 100 g cover plate and the cylinder assembly weighed. This gives an applied pressure of 20 g/cm² (0.28 psi). Alternatively, the sample can be covered with a 250 g cover plate to give an applied pressure of 51 g/cm² (0.7 psi). The screened base of the cylinder is placed in a 100 mm petri dish containing 25 milliliters of a test solution (usually 0.9% saline), and the polymer is allowed to absorb for 1 hour (or 3 hours). By reweighing the cylinder assembly, the AUL (at a given pressure) is calculated by dividing the weight of liquid absorbed by the dry weight of polymer before liquid contact.

### EXAMPLE 1

### Preparation of Poly(acrylic acid) 0% Neutralized (Poly(AA) DN=0)

A monomer mixture containing acrylic acid (270 grams), deionized water (810 grams), methylene—bisacrylamide (0.4 grams), sodium persulfate (0.547 grams), and 2-hydroxy-2-methyl-1-phenyl-propan-1-one (0.157 grams) was prepared, then sparged with nitrogen for 15 minutes. The monomer mixture was placed into a shallow glass dish, then the monomer mixture was polymerized at an initiation temperature of 10° C. under 20 mW/cm² of UV light for about 12 to about 15 minutes. The resulting poly(AA) was a rubbery gel.

The rubbery poly(AA) gel was cut into small pieces, then extruded three times through a Kitchen-Aid Model K5SS mixer with meat grinder attachment. During extrusion, sodium metabisulfite was added to gel to react with unreacted monomer. The extruded gel was dried in a forced-air oven at 145° C. for 90 minutes, and finally ground and sized through sieves to obtain the desired particle size of about 180 to about 710 μm (microns).

This procedure provided a lightly crosslinked polyacrylic acid with a degree of neutralization of zero (DN=0). The polyacrylic acid (DN=0) absorbed 119.5 g of 0.1 M sodium hydroxide (NaOH) per gram of polymer and 9.03 g synthetic urine per gram of polymer under a load of 0.7 psi.

### EXAMPLE 2

### Preparation of Poly(dimethylaminoethyl acrylamide) (Poly (DAEA))

A monomer mixture containing 125 grams N-(2-dimethylaminoethyl) acrylamide (DAEA), 300 grams deionized water, 0.6 gram methylenebisacrylamide, and 0.11 grams V-50 initiator (i.e., 2,2′-azobis(2-amidinopropane)hydrochloride initiator available from Wako Pure Chemical Industries, Inc., Osaka, Japan) was sparged with argon for 15 minutes. Then the resulting reaction mixture was placed in a shallow dish and polymerized under 15 mW/cm² of UV light for 25 minutes. The polymerization was exothermic, eventually reaching about 100° C. The resulting lightly crosslinked poly(DAEA) was a rubbery gel. The rubbery poly(DAEA) gel was crumbled by hand, then dried at 60° C. for 16 hours, and finally ground and sized through sieves to obtain the desired particle size.

### EXAMPLE 3

### Preparation of Poly(dimethylaminopropyl methacrylamide) (Poly(DMAPMA))

A monomer mixture containing DMAPMA monomer (100 grams), deionized water (150 grams), methylenebisacrylamide (0.76 grams) and V-50 initiator (0.72 grams) was placed in a glass beaker. The monomer mixture was purged with argon for 25 minutes, covered, and then placed in an oven at about 60° C. for about 60 hours. The resulting lightly crosslinked poly(DMAPMA) was a rubbery gel. The rubbery poly(DMAPMA) gel was crumbled by hand, dried at 60° C. for 16 hours, and then ground and sized through sieves to obtain the desired particle size.

### EXAMPLE 4

### Preparation of a Poly(N-vinylformamide) and a Poly(vinylamine)

A monomer mixture containing N-vinylformamide (250 grams), deionized water (250 grams), methylenebisacrylamide (1.09) grams), and V-50 initiator (0.42 grams) was placed in a shallow dish, then polymerized under an ultraviolet lamp as set forth in Example 1 until the mixture polymerized into a rubbery gel. The lightly crosslinked poly(N-vinylformamide) then was hydrolyzed with a sodium hydroxide solution to yield a lightly crosslinked poly(vinylamine).

### EXAMPLE 5

### Preparation of a Strong Acidic Water-Absorbing Resin

A monomer mixture containing acrylic acid (51 grams), 2-acrylamido-2-methyl-1-propanesulfonic acid (AMPS, 25.8 grams), deionized water (230 grams), methylenebisacrylamide (0.088 grams), sodium persul—fate (0.12 grams), and 2-hydroxy-2-methyl-1-phenylpropan-1-one (0.034 grams) was prepared, then placed in shallow dish and polymerized under an ultraviolet lamp as set forth in Example 1 until the monomer mixture polymerizes into rubbery gel.

The gel was cut into small pieces then extruded through a KitchenAid Model K5SS mixer with a meat grinder attachment. The extruded gel then was dried in a forced-air oven at 120° C., ground, and sized through sieves to obtain the desired particle size.

The resulting lightly crosslinked acidic resin contained 15 mole percent strong acid functionality (—SO₃H) and 85 mole percent weak acid functionality (—CO₂H)

### EXAMPLE 6

### Preparation of a Crosslinked Poly(vinyl alcohol-co-vinylamine) Resin

Poly(vinyl alcohol-co-vinylamine) (50 grams, 6 mol % vinylamine), available from Air Products Inc., Allentown, Pa., was dissolved in 450 grams of deionized water in a glass jar to form a viscous solution. Ethylene glycol diglycidyl ether (0.2 grams) was added to the viscous solution, with stirring. The jar then was covered and placed in a 60° C. oven for 16 hours to yield a rubbery gel of a lightly crosslinked poly(vinyl alcohol-co-vinylamine).

### EXAMPLE 7

### Preparation of a Crosslinked Poly(vinylamine) Resin

To 100 g of an 8% by weight aqueous poly(vinylamine) solution was added about 2 mol % (0.66 g) of ethylene glycol diglycidyl ether (EGDGE). The resulting mixture was stirred for about 5 minutes to dissolve the EGDGE, then the homogeneous mixture was placed in an oven, heated to about 60° C., and held for two hours to gel. The resulting gel then was extruded three times, and dried to a constant weight at 60° C. The dried, lightly crosslinked poly(vinylamine) (poly(VAm)) then was cryogenically milled to form a granular material (about 180 to about 710 μm). The crosslinked poly(VAm) absorbed 59.12 g/g of 0.1 M hydrochloric acid under no load, and 17.3 g/g of synthetic urine under a load of 0.7 psi.

### EXAMPLE 8

### Preparation of Poly(vinylquanadine) (Poly(VG))

To 500 ml of an aqueous solution of poly(vinylamine) (1.98% solids, 93% hydrolyzed) was added 38.5 ml of 6M hydrochloric acid and 9.65 g of cyanamide (H₂NCN). The resulting solution was heated under reflux for 8 hours. The solution next was diluted to a volume of 3L (liters) with a 5% sodium hydroxide solution, then ultrafiltered (M_{w} cut off of 100,000) with 15L of a 5% sodium hydroxide solution, followed by 15L of deionized water. The resulting product was concentrated to a 2.6% solids solution, having a pH 11.54. A poly(vinylamine) solution has a pH 10.0. The 2.6% solids solution gave a negative silver nitrate test, and a gravimetric analysis of the polymer, after the addition of HCl, gave the following composition: vinylguanidine 90%, vinylformamide 7%, and vinylamine 3%. Infrared analysis shows a strong absorption at 1651 cm⁻¹, which is not present in poly(vinylamine), and corresponds to a C═N stretch.

### EXAMPLE 9

### Preparation of a Crosslinked Poly(VG) Resin

The 2.6% solids solution of Example 8 was further concentrated to 12.5% solids by distillation. To this 12.5% solids solution was added 1 mole % EGDGE, and the resulting solution then was heated in a 60° C. oven for 5 hours to form a gel of lightly crosslinked poly(vinylguanidine).

### EXAMPLE 10

### Preparation of a Coextruded Poly(VG)/Poly(AA) Multicomponent SAP

The crosslinked poly(VG) hydrogel of Example 9 was coextruded with 1 mole equivalent of the poly(AA) of Example 1 as follows. The poly(VG) of Example 9 was extruded through a KitchenAid Model K5SS mixer with meat grinder attachment. The poly(AA) hydrogel of Example 1 also was extruded through a KitchenAid Model K5SS mixer with meat grinder attachment. The two extrudates then were combined via hand mixing, followed by extruding the resulting mixture two times using the meat grinder. The extruded product then was dried for 16 hours at 60° C., milled and sized to 180-710 microns.

In Example 10, interfacial crosslinks were provided by a direct reaction between carboxylic acid groups of the acidic resin and amine functionalities of the basic resin at the acidic resin-basic resin interfaces. The interfacial crosslinks occurred during the heating step to dry the multicomponent SAP particles. It has been found, however, that the number of such direct crosslinks can be sufficiently high to adversely affect SAP performance. In accordance with the present invention, the introduction of an interfacial crosslinking agent controls the amount of interfacial crosslinks. Accordingly, the benefits of interfacial crosslinking are achieved, while the disadvantages are eliminated.

### EXAMPLE 11

### General Preparation of a Multicomponent SAP Interfacially Crosslinked With an Interfacial Crosslinking Agent

The following is a general procedure for the production of a multicomponent SAP of the present invention containing poly(vinylamine) as the basic resin, poly(acrylic acid) as the acidic resin, and ethylene glycol diglycidyl ether (EGDGE) as the interfacial crosslinking agent. In the following additional examples, the degree of neutralization (DN) of the resins, the amount of interfacial crosslinking agent, and other parameters were varied to illustrate the present invention more fully.

First, poly(vinylamine) was prepared by adding EGDGE (3 mole %) as an internal crosslinking agent to an aqueous solution of poly(VAm) (poly(vinylamine)), the resulting mixture was heated (i.e., cured) at 60° C. for two hours to internally crosslink the poly(VAm). The resulting poly(VAm) gel was extruded using a Kitchen-Aid mixer equipped with a meat grinder attachment.

A poly(acrylic acid) (i.e., poly(AA)) was prepared by admixing N,N′-methylenebisacrylamide (1.16 g) as an internal crosslinking agent, deionized water (780 g), 50% sodium hydroxide (60 g), and acrylic acid (270 g) (DN=20). This mixture provided acrylic acid neutralized 20%. The temperature of the resulting monomer mixture was reduced to 10° C., then 2-hydroxy-2-methyl-1-phenyl-1-propane, i.e., DAROCUR 1172, Ciba Additives, Tarrytown, N.Y. (0.157 g), and 10% sodium persulfate (5.471 g) were added to the mixture. The monomer mixture was irradiated at 20 mW/cm² for 12.5 minutes. The poly(AA) gel was extruded using a Kitchen-Aid mixer equipped with a meat grinder attachment. Sorbitol polyglycidyl ether (DENACOL EX-614B, Nagase Chemicals Ltd., Hyogo, Japan) (0.1 wt % based on AA) was added to the poly(AA) extrudate as an interfacial crosslinking agent in the form of a 0.5 wt % aqueous solution. The extrudate was mixed manually, then reextruded using a Kitchen-Aid mixer equipped with a meat grinder attachment. In preferred embodiments, the interfacial crosslinking agent is thoroughly mixed into the acidic resin hydrogel immediately, or shortly, after addition of the interfacial crosslinking agent to the hydrogel.

The poly(VAm) and poly(AA) extrudates were mixed manually, coextruded three times using a Kitchen-Aid mixer equipped with a meat grinder attachment, and dried at 125° C. for two hours. The resulting interfacially crosslinked multicomponent superabsorbent polymer was milled in a centrifugal mill and sized to 180-710 μM.

The above procedure produced a multicomponent SAP of the present invention containing microdomains of poly(AA) (DN=20) and poly(VAm) (DN=0) interfacially crosslinked with 700 ppm of sorbitol polyglycidyl ether, based on the dry weight of the multicomponent SAP.

### EXAMPLE 12

This examples illustrates that a multicomponent SAP containing poly(VAm) and poly(AA) (DN=30) exhibits improved interfacial crosslinking and absorption properties by the introduction of an interfacial crosslinking agent.

In the following table, the multicomponent SAP was prepared as in Example 11. The poly(AA) was 30% neutralized and internally crosslinked with 0.2 mole % N,N′-methylenebisacrylamide (MBA). The poly(VAm) had a molecular weight of about 70,000 (prior to internal crosslinking) and was internally crosslinked with 2 mole % ethylene glycol diglycidyl ether (DENECOL EX-810). The relative amounts of poly(VAm) and poly(AA) in the multicomponent SAP was 50:50 wt %. The interfacial crosslinking agent was sorbitol polyglycidyl ether. Interfacial crosslinking was achieved by heating at 125° C. for 50 minutes.

| Sam- | Dry | AUL (1 hr)²⁾ | | AUNL | AUL (4 hrs.) | | AUNL |
|---|---|---|---|---|---|---|---|
| ple | Wt %¹⁾ | 0.28 psi | 0.7 psi | (1 hr.) | 0.28 psi | 0.7 psi | (4 hrs.) |
| A | 0.00 | 35.7 | 14.5 | 62.1 | 39.4 | 18.3 | 62.6 |
| B | 0.00 | 42.6 | 16.3 | 61.7 | 44.3 | 20.0 | 61.7 |
| C | 0.05 | 49.1 | 40.5 | 59.3 | 49.2 | 44.1 | 58.8 |
| D | 0.10 | 47.3 | 42.8 | 56.5 | 47.4 | 42.8 | 56.4 |
| E | 0.15 | 48.6 | 44.4 | 58.0 | 48.6 | 43.7 | 57.3 |
| F | 0.20 | 46.7 | 43.6 | 56.3 | 46.8 | 43.0 | 56.3 |
| G | 0.20 | 45.8 | 42.8 | 54.7 | 45.5 | 42.2 | 54.4 |
| H | 0.30 | 45.2 | 43.4 | 56.4 | 45.3 | 42.6 | 55.8 |
| I | 0.40 | 44.9 | 40.9 | 54.1 | 44.7 | 40.8 | 53.7 |
| J | 0.80 | 42.2 | 38.2 | 51.3 | 41.9 | 38.0 | 50.9 |
| K | 2.00 | 38.1 | 34.2 | 46.6 | 37.9 | 34.1 | 46.0 |

¹⁾Dry wt % of interfacial crosslinking agent based on the weight of acrylic acid.
²⁾All AUL and AUNL data is in units of grams of absorbed liquid/gram of SAP.

Samples 12A and 12B show that the amount of interfacial crosslinking in the absence of an interfacial crosslinking agent is low when a DN=30 poly(AA) is used. This result is illustrated by the relatively poor absorption properties illustrated by Samples 12A and 12B compared to Samples 12C through 12I. Example 12 also illustrates that the addition of relatively high amounts of an interfacial crosslinking agent provides an amount of interfacial crosslinking, and absorption properties begin to decrease (Samples 12J and 12K). However, the absorption properties of Samples 12J and 12K are superior to samples lacking an interfacial crosslinking agent (Samples A and B).

Accordingly, a multicomponent SAP particle of the present invention contains about 0.02% to about 2%, and preferably about 0.05% to about 0.8%, by weight of an interfacial crosslinking agent, based on the dry weight of the particle. To achieve the full advantage of the present invention, a multicomponent SAP particle contains about 0.05% to about 0.4%, by weight, of an interfacial crosslinking agent, based on the dry weight of the particle.

### EXAMPLE 13

This example is similar to Example 12, except the poly(AA) in the multicomponent SAP is DN=60. The following table shows that the addition of an interfacial crosslinking agent to a multicomponent SAP having a DN=60 poly(AA) provides less of an improvement in absorption than in a multicomponent SAP containing a DN=30 poly(AA). This is attributed to a lower potential for deionization. However, performance at increasing DN of the poly(AA) still is improved over conventional SAPs, e.g., a poly(AA) of DN=75.

| Sam- | Dry | AUL (1 hr) | | AUNL | AUL (4 hrs.) | | AUNL |
|---|---|---|---|---|---|---|---|
| ple | Wt %¹⁾ | 0.28 psi | 0.7 psi | (1 hr.) | 0.28 psi | 0.7 psi | (4 hrs.) |
| A | 0.00 | 37.7 | 15.4 | 53.0 | 38.5 | 18.9 | 53.0 |
| B | 0.00 | 28.4 | 16.4 | 53.8 | 35.8 | 20.2 | 54.1 |
| C | 0.05 | 36.0 | 17.8 | 48.9 | 36.3 | 23.9 | 49.0 |
| D | 0.10 | 36.2 | 28.1 | 49.0 | 35.8 | 30.2 | 48.6 |
| E | 0.15 | 35.7 | 30.6 | 48.4 | 35.6 | 30.8 | 48.4 |
| F | 0.20 | 37.2 | 31.3 | 48.0 | 37.1 | 31.7 | 47.6 |
| G | 0.20 | 36.8 | 31.5 | 50.0 | 36.5 | 31.5 | 49.7 |
| H | 0.30 | 36.3 | 31.4 | 47.1 | 35.8 | 31.1 | 47.4 |
| I | 0.40 | 35.2 | 31.0 | 47.1 | 35.0 | 30.6 | 45.5 |
| J | 0.80 | 34.8 | 30.5 | 45.4 | 34.2 | 30.0 | 44.7 |
| K | 2.00 | 32.7 | 29.7 | 44.3 | 32.2 | 29.1 | 43.3 |

### EXAMPLE 14

This example is similar to Examples 12 and 13, except the poly(AA) in the multicomponent SAP is DN=20. The mole ratio of poly(VAm) to poly(AA) also was varied as illustrated in the following table. In preparing the monolithic, multicomponent SAP particles of this example, for each 100 g of DN=20 poly(AA) was added 5 g of an aqueous solution containing the interfacial crosslinking agent, following by three extrusions. The resulting gel then was coextruded three times with the internally crosslinked poly(VAm). Then, interfacial crosslinking was achieved by heating for 1 hour at 125° C. in an oven.

| | | | Interfacial | | | | | | |
|---|---|---|---|---|---|---|---|---|---|
| | Blend | | Crosslinking | AUL (1 hr.) | | AUNL | AUL (4 hrs.) | | AUNL |
| Sample | Ratio³⁾ | Dry Wt %¹⁾ | Agent | 0.28 psi | 0.7 psi | (1 hr.) | 0.28 psi | 0.7 psi | (4 hrs.) |
| A | 30/70 | 0 | None | 19.8 | 12.3 | 66.6 | 22.3 | 16.3 | 67.2 |
| B | 30/70 | 0.1 | EX-614B⁴⁾ | 48.2 | 43.9 | 57.5 | 48.7 | 45.2 | 47.9 |
| C | 30/70 | 0.2 | EX-614B | 47.0 | 43.0 | 55.0 | 47.2 | 43.0 | 55.0 |
| D | 30/70 | 0.4 | EX-614B | 42.1 | 38.6 | 48.8 | 41.8 | 37.8 | 48.4 |
| E | 30/70 | 0.8 | EX-614B | 39.4 | 36.1 | 46.8 | 39.4 | 36.0 | 46.1 |
| F | 50/50 | 0 | None | 29.4 | 12.5 | 63.8 | 30.3 | 16.2 | 63.1 |
| G | 50/50 | 0.1 | EX-861⁵⁾ | 54.0 | 45.4 | 63.8 | 53.8 | 48.4 | 63.9 |
| H | 50/50 | 0.2 | EX-861 | 52.3 | 47.9 | 61.4 | 51.8 | 47.7 | 61.2 |
| I | 50/50 | 0.4 | EX-861 | 50.7 | 46.3 | 59.9 | 51.0 | 46.4 | 59.5 |
| J | 50/50 | 0.8 | EX-861 | 47.5 | 43.5 | 56.5 | 47.7 | 43.7 | 56.0 |

³⁾mole ratio of poly (VAm) to poly(AA);
⁴⁾sorbitol polyglycidyl ether; and
⁵⁾polyethylene glycol diglycidyl ether.

Example 14 illustrates a substantial improvement in absorption properties in a monolithic multicomponent SAP containing an acidic resin of low DN, i.e., DN=0 to D=30, using a very low amount of interfacial crosslinking agent. See Samples 14B and 14G compared to Samples 14A and 14F. An excellent improvement in absorption properties also was demonstrated for a multicomponent SAP having a relatively high amount of interfacial crosslinking agent (Samples 14E and 14J). Example 14 also shows that various compounds can be used as the interfacial crosslinking agent.

### EXAMPLE 15

This example shows that interfacial crosslinking occurs at 0.1 to 0.2 wt % of interfacial crosslinking agent for various multicomponent SAP particles. Example 15 also shows that additional interfacial crosslinks can form after prolonged drying times. The multicomponent SAP particles of Example 15 contained poly(AA) (DN=20%) and poly(VAm). The multicomponent SAP particles were prepared by adding an aqueous solution of the interfacial crosslinking agent to the poly(AA), followed by a single extrusion. The resulting poly(AA)-interfacial crosslinking agent mixture then was extruded three times with the poly(VAm), followed by drying to form interfacial crosslinks.

| | | | Interfacial | | | | | | |
|---|---|---|---|---|---|---|---|---|---|
| | Blend | | Crosslinking | AUL (1 hr.) | | AUNL | AUL (4 hrs.) | | AUNL |
| Sample | Ratio³⁾ | Dry Wt %¹⁾ | Agent | 0.28 psi | 0.7 psi | (1 hr.) | 0.28 psi | 0.7 psi | (4 hrs.) |
| A | 30/70 | 0 | None | 17.9 | 12.5 | 68.3 | 22.9 | 16.8 | 69.8 |
| B | 30/70 | 0.05 | EX-614B⁴⁾ | 50.4 | 27.0 | 60.4 | 51.2 | 36.4 | 61.4 |
| C | 30/70 | 0.10 | EX-614B | 49.4 | 44.7 | 58.0 | 49.5 | 44.7 | 58.0 |
| D | 30/70 | 0.20 | EX-614B | 48.0 | 44.0 | 56.2 | 48.2 | 44.1 | 56.7 |
| E | 50/50 | 0 | None | 31.2 | 12.8 | 67.9 | 32.0 | 16.6 | 68.9 |
| F | 50/50 | 0.05 | EX-861⁵⁾ | 53.3 | 15.4 | 65.8 | 54.1 | 19.2 | 65.7 |
| G | 50/50 | 0.10 | EX-861 | 53.4 | 31.5 | 63.2 | 53.2 | 35.7 | 63.2 |
| H | 50/50 | 0.20 | EX-861 | 52.2 | 46.7 | 62.1 | 51.9 | 46.9 | 61.3 |
| I | 50/50 | 0 | None | 44.5 | 13.6 | 65.9 | 45.8 | 17.6 | 66.5 |
| J | 50/50 | 0.05 | EX-861 | 53.3 | 16.0 | 63.9 | 53.2 | 20.2 | 63.8 |
| K | 50/50 | 0.10 | EX-861 | 51.2 | 41.4 | 62.3 | 51.0 | 43.7 | 61.8 |
| L | 50/50 | 0.20 | EX-861 | 50.5 | 45.5 | 60.7 | 50.1 | 45.3 | 59.9 |

⁶⁾Samples 15A-15H were dried at 60° C. overnight, then at 125° C. for 1 hour. Samples 15I-15L were dried at 60° C. overnight, then at 125° C. for 2 hours.

Example 15 shows that low amounts (0.05 dry wt %) of interfacial crosslinking agent substantially improved absorption properties of the multicomponent SAP.

### EXAMPLE 16

This example shows that very low amounts (e.g., 0.02 dry wt %) of interfacial crosslinking agent substantially improves the absorption properties of the multicomponent SAP. The multicomponent SAP contained poly(AA) (DN=20) internally crosslinked with 0.2 mole % N,N-methylenebisacrylamide and poly(VAm) internally crosslinked with EGDGE. The multicomponent SAP was prepared as set forth in Example 14. Interfacial crosslinking was achieved by heating at 1250 for 1 hour (Samples 16A-16F) or for 2 hours (Samples 16G-16I). The interfacial crosslinking agent was sorbitol polyglycidyl ether.

| | Blend | | AUL (1 hr.) | | AUNL | AUL (4 hrs.) | | AUNL |
|---|---|---|---|---|---|---|---|---|
| Sample | Ratio³⁾ | Dry wt %¹⁾ | 0.28 psi | 0.7 psi | (1 hr.) | 0.28 psi | 0.7 psi | (4 hrs.) |
| A | 30/70 | 0 | 31.8 | 12.2 | 66.2 | 33.6 | 16.4 | 67.3 |
| B | 30/70 | 0.02 | 52.0 | 14.8 | 63.4 | 52.5 | 19.0 | 63.8 |
| C | 30/70 | 0.04 | 50.3 | 20.5 | 61.2 | 50.7 | 29.9 | 61.5 |
| D | 30/70 | 0.06 | 49.2 | 41.2 | 58.8 | 49.1 | 44.5 | 58.7 |
| E | 30/70 | 0.08 | 48.4 | 44.2 | 56.7 | 48.2 | 43.7 | 56.6 |
| F | 30/70 | 0.10 | 48.7 | 43.1 | 57.4 | 48.8 | 44.2 | 57.4 |
| G | 30/70 | 0.04 | 50.6 | 20.9 | 60.4 | 50.7 | 27.7 | 60.6 |
| H | 30/70 | 0.06 | 49.5 | 38.5 | 58.7 | 49.4 | 42.9 | 58.5 |
| I | 30/70 | 0.08 | 48.1 | 43.9 | 56.2 | 48.4 | 43.7 | 56.0 |

### EXAMPLE 17

This example shows that different interfacial crosslinking agents can be used to achieve crosslinks at the interface between acidic resin domains and basic resin domains. In this example, the multicomponent SAP contained a 30:70 mole ratio of poly(VAm) internally crosslinked with EGDGE to poly(AA) (DN=30) internally crosslinked with N,N′-methylenebisacrylamide. The amount of interfacial crosslinking agent was 0.4 wt % based on the amount of poly(AA). The multicomponent SAP was prepared as in Example 14, with drying at 125° C. for 2 hours.

| | Interfacial | Dry | | AUL (1 hr.) | AUNL | AUL (4 hrs.) | AUNL |
|---|---|---|---|---|---|---|---|
| Sample | Crosslinking Agent⁷⁾ | wt %¹⁾ | WPE⁸⁾ | 0.7 psi | (1 hr.) | 0.7 psi | (4 hrs.) |
| A | None | — | — | 13.0 | 67.6 | 17.2 | 68.6 |
| B | I | 0.4 | — | 13.8 | 65.1 | 18.0 | 66.5 |
| C | II | 0.4 | 112 | 42.1 | 51.2 | 42.4 | 54.1 |
| D | III | 0.4 | 180 | 42.9 | 56.3 | 43.9 | 56.5 |
| E | IV | 0.4 | 195 | 41.6 | 56.4 | 42.9 | 56.7 |
| F | IV | 0.4 | 276 | 41.3 | 55.5 | 42.7 | 55.8 |
| G | IV | 0.4 | 394 | 34.6 | 59.6 | 42.3 | 60.3 |
| H | IV | 0.4 | 587 | 19.4 | 61.0 | 29.0 | 61.3 |

⁷⁾I—poly(AA)
II—EGDGE
III—sorbital polyglycidyl ether
IV—polyethylene glycol diclycidyl ether; and
⁸⁾epoxy equivalent weight of the interfacial crosslinking agent.

These additional samples were tests conducted on a multicomponent SAP containing a 50:50 mole ratio of acidic and basic resins described and prepared as above.

| | Interfacial | Dry | | AUL (1 hr.) | AUNL | AUL (4 hrs.) | AUNL |
|---|---|---|---|---|---|---|---|
| Sample | Crosslinking Agent⁷⁾ | wt %¹⁾ | WPE⁸⁾ | 0.7 psi | (1 hr.) | 0.7 psi | (4 hrs.) |
| I | None | — | — | 14.4 | 66.3 | 18.9 | 66.4 |
| J | I | 0.4 | — | 12.6 | 66.5 | 17.0 | 66.5 |
| K | II | 0.4 | 112 | 42.9 | 56.3 | 42.6 | 55.8 |
| L | III | 0.4 | 180 | 43.2 | 58.4 | 43.3 | 57.7 |
| M | IV | 0.4 | 195 | 43.4 | 57.3 | 42.7 | 56.0 |
| N | IV | 0.4 | 276 | 44.8 | 57.7 | 43.9 | 57.0 |
| O | IV | 0.4 | 394 | 43.9 | 60.2 | 44.0 | 59.7 |
| P | IV | 0.4 | 587 | 44.9 | 62.4 | 46.2 | 61.9 |

### EXAMPLE 18

In this example, tests were performed on a multicomponent SAP comprising a 30:70 mole ratio of poly(VAm) internally crosslinked with 0.2 mole % EGDGE and poly(AA) (DN=20) internally crosslinked with N,N′-methylenebisacrylamide. The interfacial crosslinking agent was EGDGE, added in the amounts shown in the following table. The monolithic, multicomponent SAP was prepared as in Example 15, followed by drying for 2 hours at 125° C.

| | Dry | AUL (1 hr.) | | AUNL | AUL (4 hrs.) | | AUNL | SFC | DPUP |
|---|---|---|---|---|---|---|---|---|---|
| Sample | Wt %¹⁾ | 0.28 psi | 0.7 psi | (1 hr.) | 0.28 psi | 0.7 psi | (4 hrs.) | AVE⁹⁾ | (16 hrs.) |
| A | 0.00 | 44.7 | 12.3 | 67.3 | 47.4 | 16.3 | 68.6 | 0 | 25.6 |
| B | 0.05 | 52.5 | 20.9 | 62.0 | 53.3 | 29.6 | 62.5 | 6 | 36.8 |
| C | 0.10 | 50.2 | 42.2 | 60.3 | 51.2 | 44.7 | 60.7 | 17 | 47.5 |
| D | 0.15 | 49.5 | 44.0 | 58.8 | 50.1 | 45.3 | 59.0 | 51 | 47.3 |
| E | 0.40 | 45.8 | 41.6 | 53.3 | 45.8 | 41.9 | 53.0 | 160 | 43.0 |

⁹⁾average of four replicates tests.

The test data shows that permeability, presented as SFC (saline flow conductivity), increases proportionally with interfacial crosslinking levels. DPUP increases to a maximum, then decreases.

### EXAMPLE 19

In this example, the weight ratio of basic resin to acidic resin in the multicomponent SAP was varied from 50:50 to 5:95. The acidic resin was poly(AA) of varying DN, internally crosslinked with 0.2 mole % N,N′-methylenebisacrylamide. The basic resin was poly(VAm) (MW-90,000) internally crosslinked with 2 mole % EGDGE. The interfacial crosslinking agent was sorbitol polyglycidyl ether, at 0.4 wt % based on the weight of poly(AA), and was added as a 2 wt % aqueous solution. The multicomponent SAP was prepared by extruding the poly(AA)-interfacial crosslinking agent three times, followed by a single extrusion with the poly(VAm). The resulting product was dried at 125° C. for 1 hour.

| | | | AUL (1 hr.) | | AUNL | AUL (4 hrs.) | | AUNL |
|---|---|---|---|---|---|---|---|---|
| Sample | Blend Ratio³⁾ | DN | 0.28 psi | 0.7 psi | (1 hr.) | 0.28 psi | 0.7 psi | (4 hrs.) |
| A | 50/50 | 30 | 48.1 | 44.4 | 58.2 | 47.3 | 42.9 | 57.1 |
| B | 50/50 | 40 | 49.3 | 42.9 | 58.2 | 47.8 | 42.1 | 57.2 |
| C | 50/50 | 50 | 42.6 | 36.9 | 52.1 | 41.5 | 36.7 | 51.1 |
| D | 50/50 | 60 | 38.2 | 32.7 | 51.0 | 37.8 | 32.8 | 50.8 |
| E | 50/50 | 70 | 34.9 | 26.4 | 47.4 | 35.1 | 28.1 | 47.6 |
| F | 50/50 | 80 | 33.0 | 26.2 | 44.0 | 32.8 | 27.5 | 43.8 |
| G | 30/70 | 30 | 50.1 | 45.6 | 60.0 | 49.8 | 45.8 | 59.7 |
| H | 30/70 | 40 | 49.2 | 38.4 | 59.2 | 48.7 | 43.3 | 58.5 |
| I | 30/70 | 50 | 44.4 | 28.7 | 55.8 | 44.3 | 37.8 | 55.2 |
| J | 30/70 | 60 | 41.7 | 18.7 | 52.4 | 41.4 | 29.7 | 51.6 |
| K | 30/70 | 70 | 37.4 | 15.5 | 49.6 | 34.7 | 23.2 | 49.1 |
| L | 30/70 | 80 | 34.5 | 19.3 | 49.4 | 38.0 | 27.0 | 48.7 |
| M | 5/95 | 30 | 35.3 | 15.5 | 50.0 | 35.9 | 22.1 | 50.5 |
| N | 5/95 | 40 | 33.4 | 14.5 | 46.1 | 33.9 | 21.4 | 46.5 |
| O | 5/95 | 50 | 28.8 | 11.4 | 51.8 | 34.6 | 17.1 | 51.9 |
| P | 5/95 | 60 | 21.9 | 12.7 | 54.2 | 29.9 | 17.2 | 54.4 |
| Q | 5/95 | 70 | 31.1 | 11.1 | 51.7 | 34.0 | 16.4 | 51.4 |
| R | 5/95 | 80 | 27.3 | 12.4 | 51.3 | 32.3 | 17.4 | 51.4 |
| S¹⁰⁾ | 5/95 | 30 | 36.5 | 30.8 | 49.1 | 37.4 | 31.5 | 49.7 |
| T | 5/95 | 40 | 33.0 | 27.7 | 44.3 | 34.0 | 28.6 | 45.3 |
| U | 5/95 | 50 | 36.3 | 31.9 | 49.9 | 36.8 | 32.3 | 50.5 |
| V | 5/95 | 60 | 34.2 | 34.6 | 53.6 | 34.9 | 34.8 | 53.9 |
| W | 5/95 | 70 | 36.9 | 31.3 | 50.0 | 37.1 | 31.8 | 50.9 |
| X | 5/95 | 80 | 33.3 | 30.8 | 50.0 | 34.8 | 31.9 | 50.8 |
| Y | 5/95 | 50 | 37.1 | 31.3 | 49.4 | 37.1 | 31.3 | 49.9 |
| Z | 5/95 | 60 | 38.4 | 31.0 | 54.6 | 38.8 | 31.9 | 54.6 |

¹⁰⁾Samples 19S-19Z were surface crosslinked with 600 ppm EGDGE by coating the multicomponent SAP particles with 0.04 wt % of the EGDGE followed by heating at 145° C. for 1 hour.

The samples of Example 20 show that as DN increases, absorption properties in general decrease. However, at a blend ratio of 5/95, the DN effect is less pronounced, and performance is improved by interfacial crosslinking.

### EXAMPLE 20

This example illustrates interfacial crosslinking improves absorption properties over a blend ratio of basic resin to acidic resin. In this example, the basic resin and acidic resin are identical as in Example 19. The poly(AA) had a DN=30. The multicomponent SAP was prepared as in Example 14, followed by heating at 125° C. for 2 hours. The interfacial crosslinking agent was sorbitol polyglycidyl ether at 0.1 dry wt % based on the amount of poly(AA).

| Sam- | Blend | AUL (1 hr.) | | AUNL | AUL (4 hrs.) | | AUNL |
|---|---|---|---|---|---|---|---|
| ple | Ratio³⁾ | 0.28 psi | 0.7 psi | (1 hr.) | 0.28 psi | 0.7 psi | (4 hrs.) |
| A | 20/80 | 41.4 | 35.6 | 50.1 | 41.2 | 37.2 | 49.7 |
| B | 25/75 | 44.4 | 40.3 | 53.0 | 44.2 | 40.5 | 52.7 |
| C | 30/70 | 47.4 | 43.2 | 55.8 | 47.1 | 43.6 | 55.8 |
| D | 35/65 | 50.6 | 45.3 | 58.6 | 50.5 | 45.2 | 58.6 |
| E | 40/60 | 50.1 | 46.1 | 59.0 | 50.2 | 45.9 | 59.0 |
| F | 45/55 | 50.7 | 45.9 | 59.0 | 50.7 | 45.5 | 58.8 |
| G | 50/50 | 49.0 | 44.3 | 58.8 | 49.2 | 44.3 | 58.4 |

This example further shows that interfacial crosslinking is very effective in improving the absorptive properties of a multicomponent SAP, and especially at ratios of basic resin to acidic resin of 35/65 to 5/95.

### EXAMPLE 21

This example shows that interfacial crosslinking provides a stable SAP particle with respect to both cure time and cure temperature. The tested multicomponent SAP contained a 30:70 ratio of poly(VAm) internally crosslinked with 3 mole % EGDGE and poly(AA) (DN=20) internally crosslinked with N,N′-methylenebisacrylamide. The multicomponent SAP was prepared by extruding the poly(AA)-interfacial crosslinking agent one time, followed by coextrusion with the poly(VAm) three times. The multicomponent SAPs were dried at the temperature and time shown in the following tables.

| | | Cure | | | | | | |
|---|---|---|---|---|---|---|---|---|
| | | Time | AUL (1 hr.) | | AUNL | AUL (4 hrs.) | | AUNL |
| Sample | Temp (° C.) | (hr.) | 0.28 psi | 0.7 psi | (1 hr.) | 0.28 psi | 0.7 psi | (4 hrs.) |
| A | 100 | 1 | 49.2 | 42.8 | 58.7 | 49.3 | 44.4 | 58.6 |
| B | 100 | 2 | 49.4 | 42.7 | 58.3 | 49.9 | 44.5 | 58.6 |
| C | 100 | 3 | 50.4 | 42.2 | 58.9 | 50.4 | 44.0 | 59.1 |
| D | 125 | 1 | 49.4 | 39.1 | 58.1 | 49.6 | 42.9 | 58.6 |
| E | 125 | 2 | 49.2 | 41.4 | 58.7 | 49.6 | 43.8 | 58.6 |
| F | 125 | 3 | 48.9 | 39.1 | 57.9 | 49.7 | 42.3 | 58.0 |
| G | 150 | 1 | 46.7 | 37.7 | 55.5 | 47.8 | 40.5 | 55.7 |
| H | 150 | 2 | 45.2 | 38.5 | 53.0 | 45.9 | 40.2 | 53.4 |
| I | 150 | 3 | 43.6 | 36.4 | 51.5 | 44.5 | 38.1 | 51.7 |
| J | 175 | 1 | 38.5 | 33.2 | 44.9 | 38.9 | 33.3 | 45.2 |
| K | 175 | 2 | 35.4 | 31.3 | 41.8 | 35.6 | 31.4 | 42.0 |
| L | 175 | 3 | 36.0 | 32.0 | 41.9 | 37.1 | 32.3 | 43.2 |
| | 100 | 1 | 49.2 | 42.8 | 58.7 | 49.3 | 44.4 | 58.6 |
| | 125 | 2 | 49.4 | 39.1 | 58.1 | 49.6 | 42.9 | 58.6 |
| | 150 | 3 | 46.7 | 37.7 | 55.5 | 47.8 | 40.5 | 55.7 |
| | 175 | 1 | 38.5 | 33.2 | 44.9 | 38.9 | 33.3 | 45.2 |

### EXAMPLE 22

This example illustrates that an uncrosslinked polyamine, like poly(VAm), can be used as the interfacial crosslinking agent when the basic resin is different from a lightly internally crosslinked poly(VAm).

In particular, multicomponent SAP particles containing 70%, by weight, lightly internally crosslinked poly(AA) (DN=0) and 30%, by weight, lightly internally crosslinked BPEI (branched polyethylenimines, MW-750,000 prior to internal crosslinking) was prepared according to Example 12. In the absence of an interfacial crosslinking agent, the multicomponent SAP exhibited an AUL (0.7 psi) of about 28.5 g of synthetic urine/g after 4 hours. An identical multicomponent SAP containing 1%, by weight, uncross—linked poly(VAm) (MW-70,000) as the interfacial crosslinking agent exhibited an AUL (0.7 psi) after 4 hours of about 34.5 g of synthetic urine/g, and an SFC of about 100 to about 200×10⁻⁷ cm³sec/g.

This example illustrates the improved absorption and permeability properties exhibited by superabsorbent SAP particles having interfacial crosslinks provided by an uncrosslinked polyamine interfacial crosslinking agent.

### EXAMPLE 23

This example shows the effect of degree of neutralization (DN) on multicomponent SAP particles containing an interfacial crosslinking agent. In this example, the multicomponent SAP contained a 50:50 or 30:70 mole ratio of poly(VAm) (internally crosslinked with EGDGE) to poly(AA) (internally crosslinked with MBA), as summarized in the following table. The interfacial crosslinking agent, EX-614B (sorbitol polyglycidyl ether), was present in an amount of about 0.2%, by weight of the dry SAP particles, and was added as a 2 wt % aqueous solution. The multicomponent SAP was prepared by extruding the poly(AA) and interfacial crosslinking agent three times, followed by a single extrusion with the poly(VAm). The resulting product was dried at 125° C. for 1 hour.

| | | AUL (1 hr.) | | AUNL | AUL (4 hrs.) | | AUNL |
|---|---|---|---|---|---|---|---|
| Sample | DN | 0.28 psi | 0.7 psi | (1 hr.) | 0.28 psi | 0.7 psi | (4 hrs.) |
| A | 30 | 48.1 | 44.4 | 58.2 | 47.3 | 42.9 | 57.1 |
| B | 40 | 49.3 | 42.9 | 58.2 | 47.8 | 42.1 | 57.2 |
| C | 50 | 42.6 | 36.9 | 52.1 | 41.5 | 36.7 | 51.1 |
| D | 60 | 38.2 | 32.7 | 51 | 37.8 | 32.8 | 50.8 |
| E | 70 | 34.9 | 26.4 | 47.4 | 35.1 | 28.1 | 47.6 |
| F | 80 | 33 | 26.2 | 44 | 32.8 | 27.5 | 43.8 |
| G | 30 | 50.1 | 45.6 | 60 | 49.8 | 45.8 | 59.7 |
| H | 40 | 49.2 | 38.4 | 59.2 | 48.7 | 43.3 | 58.5 |
| I | 50 | 44.4 | 28.7 | 55.8 | 44.3 | 37.8 | 55.2 |
| J | 60 | 41.7 | 18.7 | 52.4 | 41.4 | 29.7 | 51.6 |
| K | 70 | 37.4 | 15.5 | 49.6 | 37.7 | 23.2 | 49.1 |
| L | 80 | 34.5 | 19.3 | 49.4 | 38 | 27 | 48.7 |

11) Samples A-F contain a 50:50 mole ratio, and Samples G-L contain a 30:70 mole ratio, of poly(VAm) to poly(AA)

The above table illustrating degree of neutralization versus performance demonstrates the improved properties demonstrated by multicomponent SAPs containing an interfacial crosslinking agent. When an interfacial crosslinking agent is absent, the load performance of the SAP quickly drops below 30 g/g (i.e., at a DN of about 15-20). In contrast, when an interfacial crosslinking agent is present, the AUL (0.7 psi) values are greater than 30 g/g up to a DN of 65-70.

### EXAMPLE 24 (Comparative)

This example shows the effect of eliminating an interfacial crosslinking agent from a multicomponent SAP. The tested multicomponent SAPs were identical to those set forth in Example 12, except for degree of neutralization, and by heating at 125° C. for 60 minutes after drying overnight at 60° C. The following samples contained no interfacial crosslinking agent.

| | | | AUL (1 hr.) | | ANUL | AUL (4 hrs.) | | ANUL |
|---|---|---|---|---|---|---|---|---|
| Sample | Blend Ratio³⁾ | DN | 0.28 psi | 0.7 psi | (1 hr.) | 0.28 psi | 0.7 psi | (4 hrs.) |
| A | 30/70 | 0 | 46.3 | 40.4 | 56.5 | 48.4 | 42.8 | 59.7 |
| B | 30/70 | 10 | 39.8 | 29.4 | 50.8 | 39.2 | 31.4 | 49.8 |
| C | 30/70 | 20 | 19.8 | 12.3 | 66.6 | 22.3 | 16.3 | 67.2 |
| D | 30/70 | 30 | 16.0 | 11.6 | 67.1 | 20.9 | 16.2 | 68.2 |
| E | 50/50 | 0 | 49.9 | 45.9 | 60.9 | 54.3 | 49.4 | 65.1 |
| F | 50/50 | 10 | 51.8 | 48.1 | 62.6 | 52.1 | 48.5 | 63.2 |
| G | 50/50 | 20 | 29.4 | 12.5 | 63.8 | 30.3 | 16.2 | 63.1 |
| H | 50/50 | 30 | 24.9 | 12.9 | 63.9 | 26.2 | 17.0 | 63.7 |

The samples of comparative Example 24 show that for multicomponent SAPs having a DN=20, the interfacial curing which occurs in multicomponent SAP having a DN=0 is effectively eliminated from both the 30/70 and 50/50 blend ratios.

### EXAMPLE 25

This example illustrates that multicomponent SAPs of the present invention containing an interfacial crosslinking agent are more temperature stable than an identical multicomponent SAP free of an interfacial crosslinking agent. In this example, the basic resin and acidic resin are identical to those in Example 24. The interfacial crosslinking agent was present at 0.1 wt %, based on the amount of poly(AA).

| | | | Interfacial | Dry/Cure | | | | | | |
|---|---|---|---|---|---|---|---|---|---|---|
| | Blend | | Crosslinking | Time | AUL (1 hr.) | | ANUL | AUL (4 hrs.) | | ANUL |
| Sample | Ratio³⁾ | DN | Agent | (min.) | 0.28 psi | 0.7 psi | (1 hr.) | 0.28 psi | 0.7 psi | (4 hrs.) |
| A | 30/70 | 0 | EX-614B⁴ | 45 | 50.1 | 44.8 | 59.0 | 50.4 | 45.8 | 59.6 |
| B | 30/70 | 0 | EX-614B | 60 | 48.7 | 44.4 | 58.6 | 50.5 | 45.9 | 61.6 |
| C | 30/70 | 0 | EX-614B | 120 | 47.2 | 42.9 | 56.9 | 49.2 | 44.7 | 59.9 |
| D | 30/70 | 0 | EX-614B | 180 | 46.3 | 40.7 | 55.2 | 48.8 | 42.7 | 57.2 |
| E | 30/70 | 20 | EX-614B | 45 | 49.4 | 45.4 | 59.6 | 51.0 | 48.6 | 61.1 |
| F | 30/70 | 20 | EX-614B | 60 | 50.3 | 44.1 | 58.7 | 50.5 | 46.1 | 60.2 |
| G | 30/70 | 20 | EX-614B | 120 | 49.2 | 43.5 | 58.4 | 49.8 | 45.2 | 58.9 |
| H | 30/70 | 20 | EX-614B | 180 | 49.0 | 43.5 | 57.7 | 49.8 | 45.0 | 58.3 |
| I | 50/50 | 0 | EX-861⁵⁾ | 45 | 54.0 | 49.9 | 64.6 | 56.9 | 52.6 | 68.6 |
| J | 50/50 | 0 | EX-861 | 60 | 53.4 | 49.3 | 64.1 | 57.0 | 52.9 | 68.3 |
| K | 50/50 | 0 | EX-861 | 120 | 50.4 | 45.6 | 60.1 | 53.7 | 49.4 | 64.1 |
| L | 50/50 | 0 | EX-861 | 180 | 48.0 | 42.9 | 57.7 | 51.3 | 46.3 | 61.5 |
| M | 50/50 | 20 | EX-861 | 45 | 53.2 | 33.0 | 64.1 | 52.8 | 38.9 | 63.8 |
| N | 50/50 | 20 | EX-861 | 60 | 53.0 | 33.1/ | 64.1 | 52.6 | 40.0 | 63.9 |
| | | | | | | 37.5 | | | | |
| 0 | 50/50 | 20 | EX-861 | 120 | 52.8 | 42.8/ | 63.4 | 52.8 | 47.0 | 63.3 |
| | | | | | | 47.5 | | | | |
| P | 50/50 | 20 | EX-861 | 180 | 52.2 | 47.0 | 61.9 | 52.0 | 47.4 | 61.8 |
| Q | 30/70 | 0 | EX-614B | 300 | — | 36.9 | 52.1 | — | 39.5 | 54.5 |

The test data shows that a multicomponent SAP containing an interfacial crosslinking agent is more oven stable over time than a multicomponent SAP free of an interfacial crosslinking agent. The above tables show that absorption properties are essentially unaffected as cure time and temperatures are varied. In the absence of an interfacial crosslinking agent, the AUL and AUNL values drop by about 10 g/g when cured for 3 hours as opposed to one hour at 125° C., and about 25 g/g when cured at 175° C. as opposed to 100° C.

Heating of multicomponent SAP particles in the presence of an interfacial crosslinking agent for a sufficient time at a sufficient temperature to form covalent bonds between the acidic and basic resins improves the ability of the SAP particle to absorb and retain fluids. In particular, heating multicomponent SAP particles for about 30 to about 180 minutes at about 60° C. to about 200° C., and preferably above the Tg of one of the resins comprising the multicomponent SAP particles, forms covalent bonds at the interface between the acidic resin and basic resin via the interfacial crosslinking agent, thereby forming a monolithic SAP particle.

The covalent bonds formed at the interfaces between the acidic resin and basic resin via the interfacial crosslinking agent generates a zone in the SAP particle that is more highly crosslinked, and, if too highly crosslinked, that is less effective in absorbing liquids. Accordingly, a sufficient amount of interfacial crosslinking agent is used to form covalent bonds, but not such an amount that fluid adsorption is adversely affected.

In addition to an ability to absorb and retain relatively large amounts of a liquid, it also is important for an SAP to exhibit good permeability, and, therefore, rapidly absorb the liquid. Therefore, in addition to absorbent capacity, or gel volume, useful SAP particles also have a high gel strength, i.e., the particles do not deform after absorbing a liquid. In addition, the permeability or flow conductivity of a hydrogel formed when SAP particles swell, or have already swelled, in the presence of a liquid is extremely important property for practical use of the SAP particles. Differences in permeability or flow conductivity of the absorbent polymer can directly impact on the ability of an absorbent article to acquire and distribute body fluids.

Many types of SAP particles exhibit gel blocking. “Gel blocking” occurs when the SAP particles are wetted and swell, which inhibits fluid transmission to the interior of the SAP particles and between absorbent SAP particles. Wetting of the interior of the SAP particles or the absorbent structure as a whole, therefore, takes place via a very slow diffusion process, possibly requiring up to 16 hours for complete fluid absorption. In practical terms, this means that acquisition of a fluid by the SAP particles, and, accordingly, the absorbent structure, such as a diaper, can be much slower than the rate at which fluids are discharged, especially in gush situations. Leakage from an absorbent structure, therefore, can occur well before the SAP particles in the absorbent structure are fully saturated, or before the fluid can diffuse or wick past the “gel blocked” particles into the remainder of the absorbent structure. Gel blocking can be a particularly acute problem if the SAP particles lack adequate gel strength, and deform or spread under stress after the SAP particles swell with absorbed fluid.

Accordingly, an SAP particle can have a satisfactory AUL value, but will have inadequate permeability or flow conductivity to be useful at high concentrations in absorbent structures. In order to have a high AUL value, it is only necessary that the hydrogel formed from the SAP particles has a minimal permeability such that, under a confining pressure of 0.3 psi, gel blocking does not occur to any significant degree. The degree of permeability needed to simply avoid gel blocking is much less than the permeability needed to provide good fluid transport properties. Therefore, SAPs that avoid gel blocking and have a satisfactory AUL value can still be greatly deficient in these other fluid handling properties.

An important characteristic of the monolithic, multicomponent SAP particles of the present invention is permeability when swollen with a liquid to form a hydrogel zone or layer, as defined by the Saline Flow Conductivity (SFC) value of the SAP particles. SFC measures the ability of an SAP to transport saline fluids, such as the ability of the hydrogel layer formed from the swollen SAP to transport body fluids. A material having relatively high SFC value is an air-laid web of woodpulp fibers. Typically, an air-laid web of pulp fibers (e.g., having a density of 0.15 g/cc) exhibits an SFC value of about 200×10⁻⁷ cm³sec/g. In contrast, typical hydrogel-forming SAPs exhibit SFC values of 1×10⁻⁷ cm³sec/g or less. When an SAP is present at high concentrations in an absorbent structure, and then swells to form a hydrogel under usage pressures, the boundaries of the hydrogel come into contact, and interstitial voids in this high SAP concentration region become generally bounded by hydrogel. When this occurs, the permeability or saline flow conductivity properties in this region is generally indicative of the permeability or saline flow conductivity properties of a hydrogel zone formed from the SAP alone. Increasing the permeability of these swollen high concentration regions to levels that approach or even exceed conventional acquisition/distribution materials, such as wood pulp fluff, can provide superior fluid handling properties for the absorbent structure, thus decreasing incidents of leakage, especially at high fluid loadings.

Accordingly, it would be highly desirable to provide SAP particles having an SFC value that approaches or exceeds the SFC value of an air-laid web of wood pulp fibers. This is particularly true if high, localized concentrations of SAP particles are to be effectively used in an absorbent structure. High SFC values also indicate an ability of the resultant hydrogel to absorb and retain body fluids under normal usage conditions.

The SFC value of the present multicomponent SAP particles are substantially improved over the SFC value for a standard poly(AA) SAP. A method for determining the SFC value of SAP particles is set forth in Goldman et al. U.S. Pat. No. 5,599,335, incorporated herein by reference.

The present multicomponent SAPs interfacially crosslinked with an interfacial crosslinking agent exhibit a substantial improvement in AUL at 0.7 psi and SFC in comparison to a control SAP and a comparative dry blend of SAP particles. Accordingly, a present interfacially crosslinked multicomponent SAP particle has an SFC value of at least 50×10⁻⁷ cm³sec/g, preferably at least about 150×10⁻⁷ cm³sec/g, and more preferably at least about 250×10⁻⁷ cm³sec/g. To achieve the full advantage of the present invention, the SFC value is at least about 350×10⁻⁷ cm³sec/g, and can range to greater than 1000×10⁻⁷ cm³sec/g.

The present monolithic, multicomponent SAP particles also exhibit excellent diffusion of a liquid through and between the particles, as demonstrated by Performance Under Pressure (PUP) capacity at 0.7 psi over time. The PUP capacity test is similar to the AUL test, but the SAP particles are allowed to absorb a fluid on demand. The PUP test is designed to illustrate absorption kinetics of an SAP particle. The present multicomponent SAP particles, therefore, demonstrate a faster absorption of liquids, and a better diffusion rate of liquids into and through the particles, in addition to an ability to absorb and retain a greater amount of liquids than prior or other SAP products. The present multicomponent SAPs exhibit both a) improved absorption and retention, and b) improved permeability and absorption kinetics. Such results are both new and unexpected in the art.

The monolithic, multicomponent SAP particles also can be mixed with particles of a second water-absorbing resin to provide an SAP material having improved absorption properties. The second water-absorbing resin can be an acidic water-absorbing resin, a basic water-absorbing resin, or a mixture thereof. The SAP material comprises about 10% to about 90%, and preferably about 25% to about 85%, by weight, multicomponent SAP particles and about 10% to about 90%, and preferably, about 25% to about 85%, by weight, particles of the second water-absorbing resin. More preferably, the SAP material contains about 30% to about 75%, by weight, multicomponent SAP particles. To achieve the full advantage of the present invention, the SAP material contains about 35% to about 75%, by weight, of the multicomponent SAP particles. The multicomponent SAP particles can be prepared by any of the previously described methods, e.g., extrusion, agglomeration, or interpenetrating polymer network, and can be of any shape, e.g., granular, fiber, powder, or platelets.

The second water-absorbing resin can be any of the previously discussed acidic resins used in the preparation of a multicomponent SAP. The second water-absorbing resin, either acidic or basic, can be unneutralized (DN=0), partially neutralized (0<DN<100), or completely neutralized (DN=100). A preferred acidic water-absorbing resin used as the second resin is poly(acrylic acid), preferably partially neutralized poly(acrylic acid), e.g., DN about 50%, and preferably about 70% up to about 100%. The second water-absorbing resin also can be any of the previously discussed basic resins used in the preparation of a multicomponent SAP. Preferred basic water-absorbing resins used as the second resin are poly(vinylamine) or a poly(dialkylaminoalkyl(meth)acrylamide. Blends of acidic resins, or blends of basic resins, can be used as the second water-absorbing resin. Blends of an acidic resin and a basic resin also can be used as the second water-absorbing resin.

In addition, a significant improvement in liquid absorption, both with respect to kinetics and retention, are expected if the standard poly(AA)(DN=70) presently used in diaper cores is completely replaced by monolithic, multicomponent SAP particles, or is replaced by a superabsorbent material of the present invention, i.e., a composition containing monolithic, multicomponent SAP particles and a second water-absorbing resin, such as poly(AA) (DN=70).

The improved results demonstrated by a diaper core containing the monolithic, multicomponent SAP particles of the present invention also permit the thickness of the core to be reduced. Typically, cores contain 50% or more fluff or pulp to achieve rapid liquid absorption while avoiding problems like gel blocking. Cores which contain monolithic multicomponent SAP particles acquire liquids sufficiently fast to avoid problems, like gel blocking, and, therefore, the amount of fluff or pulp in the core can be reduced, or eliminated. A reduction in the amount of the low-density fluff results in a thinner core, and, accordingly, a thinner diaper. Therefore, a core of the present invention can contain at least 50% of an SAP, preferably at least 75% of an SAP, and up to 100% of an SAP. In various embodiments, the presence of a fluff or pulp is no longer necessary, or desired. In each case, the SAP in a present core contains multicomponent SAP particles, in an amount of about 15% to 100% of the SAP. The remaining SAP can be a second water-absorbing resin, either basic or acidic. The second water-absorbing resin preferably is not neutralized, but can have a degree of neutralization up to 100%. The monolithic multicomponent SAP particles can be admixed with particles of a second water-absorbing resin for introduction into a diaper core. Alternatively, the diaper core can contain zones of multicomponent SAP particles and zones of a second water-absorbing resin.

In addition to a thinner diaper, the present cores also allow an acquisition layer to be omitted from the diaper. The acquisition layer in a diaper typically is a nonwoven or fibrous material, typically having a high degree of void space, or “loft,” that assists in the initial absorption of a liquid. Cores containing monolithic, multicomponent SAP particles acquire liquid at a sufficient rate such that diapers free of an acquisition layer are practicable.

Many modifications and variations of the invention as hereinbefore set forth can be made without departing from the spirit and scope thereof and, therefore, only such limitations should be imposed as are indicated by the appended claims.

What is claimed is:

1. A monolithic, multicomponent superabsorbent particle comprising at least one microdomain of at least one basic water-absorbing resin covalently bound by an interfacial crosslinking agent to at least one microdomain of at least one acidic water-absorbing resin.

2. The particle of claim 1 comprising a plurality of microdomains of at least one basic water-absorbing resin covalently bound by an interfacial crosslinking agent to a plurality of microdomains of at least one acidic water-absorbing resin.

3. The particle of claim 1 wherein the basic resin comprises a strong basic resin, and the acidic resin comprises a strong acidic resin, a weak acidic resin, or a mixture thereof.

4. The particle of claim 1 wherein the basic resin comprises a weak basic resin, and the acidic resin comprises a strong acidic resin, a weak acidic resin, or a mixture thereof.

5. The particle of claim 1 having a mole ratio of acidic resin to basic resin of about 95:5 to about 5:95.

6. The particle of claim 1 containing about 50% to 100%, by weight, of basic resin plus acidic resin.

7. The particle of claim 1 wherein the particle is about 10 to about 10,000 microns in diameter.

8. The particle of claim 1 wherein the basic resin is lightly internally crosslinked and has about 60% to 100% basic moieties present in a free base form.

9. The particle of claim 1 wherein at least 6% of the monomer units comprising the basic resin are basic monomer units.

10. The particle of claim 1 wherein the basic resin is selected from the group consisting of a poly(vinylamine), a polyethylenimine, a poly(vinylguanidine), a poly(allylguanidine), a poly(allylamine), a guanidine-modified polystyrene, a poly(diallylamine), a copolymer of a dialkylamino acrylate and a monomer having a primary amino, a secondary amino, or a hydroxy functionality, poly(vinyl alcohol-co-vinylamine), and mixtures thereof.

11. The particle of claim 1 wherein the acidic resin contains a plurality of carboxylic acid, sulfonic acid, sulfuric acid, phosphonic acid, or phosphoric acid groups, or a mixture thereof.

12. The particle of claim 1 wherein the acidic resin is lightly internally crosslinked and has about 40% to 100% acid moieties present in the free acid form.

13. The particle of claim 1 wherein at least 10% of the monomer units comprising the acidic resin are acidic monomer units.

14. The particle of claim 1 wherein the acidic resin is selected from the group consisting of polyacrylic acid, a hydrolyzed starch-acrylonitrile graft copolymer, a starch-acrylic acid graft copolymer, a saponified vinyl acetate-acrylic ester copolymer, a hydrolyzed acrylonitrile polymer, a hydrolyzed acrylamide copolymer, an ethylene-maleic anhydride copolymer, an isobutylene-maleic anhydride copolymer, a poly(vinylphosphonic acid), a poly(vinylsulfonic acid), a poly(vinylphosphoric acid), a poly(vinylsulfuric acid), a sulfonated polystyrene, a poly(aspartic acid), a poly(lactic acid), and mixtures thereof.

15. The particle of claim 1 wherein the basic resin comprises a poly(vinylamine), a poly(vinylguanidine), a polyethylenimine, or a mixture thereof, and the acidic resin comprises poly(acrylic acid).

16. The particle of claim 15 wherein the poly(acrylic acid) resin further contains strong acid moieties.

17. The particle of claim 1 further comprising at least one microdomain of a matrix resin in an amount up to about 50% by weight of the particle.

18. The particle of claim 1 consisting essentially of microdomains of the acidic resin and the basic resin.

19. The particle of claim 1 wherein the interfacial crosslinking agent is a polyfunctional compound capable of interaction with an acidic moiety of the acidic resin and a basic moiety of the basic resin to form a covalent bond at an interface of an acidic resin microdomain and a basic resin microdomain.

20. The particle of claim 1 wherein the interfacial crosslinking agent is selected from the group consisting of:
(a) a multifunctional aziridine;
(b) a halohydrin;
(c) a multifunctional epoxy compound;
(d) a multifunctional carboxylic acid and ester, acid chloride, and anhydride derived therefrom;
(e) a multifunctional isocyanate;
(f) a β-hydroxyalkylamide;
(g) an uncrosslinked polyamine;
(h) a cyclic urethane;
(i) an alkylene carbonate, and
(j) mixtures thereof.

21. The particle of claim 1 wherein the interfacial crosslinking agent is selected from the group consisting of a multifunctional epoxy compound, a β-hydroxyalkylamide, a polyamine, and mixtures thereof.

22. The particle of claim 1 wherein the interfacial crosslinking agent is present in an amount of about 0.02% to about 2%, by weight, based on the amount of acidic resin in the particle.

23. The particle of claim 1 wherein the interfacial crosslinking agent is present in an amount of about 0.05% to about 0.8%, by weight, based on the amount of acidic resin in the particle.

24. The particle of claim 15 wherein the interfacial crosslinking agent is selected from ethylene glycol diglycidyl ether, an uncrosslinked poly(vinylamine), sorbitol polyglycol ether, polyethylene glycol diglycidyl ether, and mixtures thereof.

25. An article comprising a multicomponent superabsorbent particle of claim 1.

26. A method of absorbing an aqueous medium comprising contacting the medium with a plurality of particles of claim 1.

27. The method of claim 26 wherein the aqueous medium contains electrolytes.

28. The method of claim 27 wherein the electrolyte-containing aqueous medium is selected from the group consisting of urine, saline, menses, and blood.

29. A multicomponent superabsorbent particle comprising at least one microdomain of a first water-absorbing resin covalently bound by an interfacial crosslinking agent at least one microdomain of a second water-absorbing resin.

30. The particle of claim 29 in the form of a bead, a granule, a flake, an interpenetrating polymer network, a fiber, an agglomerated particle, a laminate, a powder, a foam, or a sheet.

31. The particle of claim 29 having an absorption under load at 0.7 psi of at least about 20 grams of 0.9% saline per gram of particles, after one hour, and at least about 25 grams of 0.9% saline per gram of particles after four hours.

32. The particle of claim 29 having a saline flow conductivity value of at least 50×10⁻⁷ cm³sec/g.

33. The particle of claim 29 having a saline flow conductivity value of at least 150×10⁻⁷ cm³sec/g.

34. The particle of claim 29 wherein the first water-absorbing resin is an acidic water-absorbing resin, and the second water-absorbing resin is a basic water-absorbing resin.

35. A superabsorbent material comprising:
(a) monolithic, multicomponent superabsorbent particles of claim 1, and
(b) particles of a second water-absorbing resin selected form the group consisting of an acidic water-absorbing resin, a basic water-absorbing resin, and mixtures thereof.

36. The superabsorbent material of claim 35 wherein the monolithic, multicomponent superabsorbent particles are present in an amount of about 10% to about 90%, by weight, of the material.

37. The superabsorbent material of claim 35 wherein the second water-absorbing resin is 0% to 100% neutralized.

38. The superabsorbent material of claim 35 wherein the second water-absorbing resin has a degree of neutralization from 0 to 70.

39. The superabsorbent material of claim 35 wherein the second water-absorbing resin comprises an acidic water-absorbing resin.

40. The superabsorbent material of claim 35 wherein the second water-absorbing resin comprises a basic water-absorbing resin.

41. A method of absorbing an aqueous medium comprising contacting the medium with a superabsorbent material of claim 35.

42. An article comprising a core containing a superabsorbent material of claim 35, said core comprising about 1% to 100% by weight of the superabsorbent material.

43. A method of manufacturing a monolithic, multicomponent superabsorbent particle comprising:
(a) forming a gel of a lightly internally crosslinked basic resin;
(b) forming a gel of a lightly internally crosslinked acidic resin;
(c) admixing an interfacial crosslinking with the gel of step (b),
(d) admixing the gel of step (a) with the gel of step (c) to form a gel having at least one microdomain of the acidic resin and at least one microdomain of the basic resin; and
(e) heating the gel of step (d) for a sufficient time at a sufficient temperature to form covalent bonds at an interface between the microdomains of acidic resin and microdomains of basic resin by the interfacial crosslinking agent.

44. The method of claim 43 wherein the gel of step (d) is heated in step (e) at a temperature of about 60° C. to about 150° C. for about 20 to about 120 minutes.

45. The method of claim 43 wherein the lightly internally crosslinked basic resin is neutralized 0% to about 40%.

46. The method of claim 43 wherein the lightly internally crosslinked acidic resin is neutralized 0% to about 60%.

47. The method of claim 43 wherein admixing in steps (c) or (d), or both, is an extrusion.
